(19) United States
(12) Patent Application Publication
(10) Pub. No.: US 2026/0113148 A1
(43) Pub. Date: Apr. 23, 2026

(54) TECHNIQUES FOR RADIO ACCESS NETWORK SIGNALING FOR FORWARD ERROR CORRECTION AWARENESS AND PACKET DATA UNIT SET INFORMATION MARKING

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US); Hyun Yong LEE, San Diego, CA (US); Sebastian SPEICHER, Wallisellen (CH)

(21) Appl. No.: 18/920,748

(22) Filed: Oct. 18, 2024

(51) Int. Cl. H04L 1/00; H04W 28/02

(52) U.S. Cl. CPC H04L 1/0076; H04W 28/0268

(57) ABSTRACT

Methods, systems, and devices for wireless communications are described. A first radio access network (RAN) node may receive, from a second node, a first indication of a forward error correction (FEC) content ratio for a data traffic flow. The data traffic flow may include one or more packet data unit (PDU) sets associated with a quality of service (QoS) flow. The first RAN node may transmit an FEC report that indicates a number of PDUs, of the one or more PDU sets, that were discarded from a buffer of a distributed unit (DU) associated with the first RAN node. The FEC report may be based on the FEC content ratio.

### FIELD OF DISCLOSURE

The present disclosure, for example, relates to wireless communications, more particularly to techniques for inclusion of radio access network (RAN) signaling for forward error correction (FEC) awareness and packet data unit (PDU) set information marking.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first radio access network (RAN) node is described. The method may include receiving, from a second node, a first indication of a forward error correction (FEC) content ratio for a data traffic flow, where the data traffic flow includes one or more packet data unit (PDU) sets associated with a quality of service (QoS) flow and transmitting, based on the FEC content ratio, an FEC report that indicates a number of discarded PDUs of the one or more PDU sets, where the discarded PDUs are discarded from a buffer of a distributed unit (DU) associated with the first RAN node.

A first radio access network (RAN) node for wireless communications is described. The first radio access network (RAN) node may include one or more memories storing processor executable code, and one or more processors coupled with the one or more memories. The one or more processors may individually or collectively be operable to execute the code to cause the first radio access network (RAN) node to receive, from a second node, a first indication of a forward error correction (FEC) content ratio for a data traffic flow, where the data traffic flow includes one or more packet data unit (PDU) sets associated with a quality of service (QoS) flow and transmit, based on the FEC content ratio, an FEC report that indicates a number of discarded PDUs of the one or more PDU sets, where the discarded PDUs are discarded from a buffer of a distributed unit (DU) associated with the first RAN node.

Another first radio access network (RAN) node for wireless communications is described. The first radio access network (RAN) node may include means for receiving, from a second node, a first indication of a forward error correction (FEC) content ratio for a data traffic flow, where the data traffic flow includes one or more packet data unit (PDU) sets associated with a quality of service (QoS) flow and means for transmitting, based on the FEC content ratio, an FEC report that indicates a number of discarded PDUs of the one or more PDU sets, where the discarded PDUs are discarded from a buffer of a distributed unit (DU) associated with the first RAN node.

A non-transitory computer-readable medium storing code for wireless communications is described. The code may include instructions executable by one or more processors to receive, from a second node, a first indication of a forward error correction (FEC) content ratio for a data traffic flow, where the data traffic flow includes one or more packet data unit (PDU) sets associated with a quality of service (QoS) flow and transmit, based on the FEC content ratio, an FEC report that indicates a number of discarded PDUs of the one or more PDU sets, where the discarded PDUs are discarded from a buffer of a distributed unit (DU) associated with the first RAN node.

In some examples of the method, first radio access networks (RANs), and non-transitory computer-readable medium described herein, the first indication may be included in an information element of a first message.

In some examples of the method, first radio access networks (RANs), and non-transitory computer-readable medium described herein, the first indication may be included in a first message at a QoS flow level.

In some examples of the method, first radio access networks (RANs), and non-transitory computer-readable medium described herein, the first RAN node includes a centralized unit-control plane (CU-CP) and the second node includes a session management function (SMF) of a core network.

In some examples of the method, first radio access networks (RANs), and non-transitory computer-readable medium described herein, the first indication may be included in a PDU session resource setup request message or a PDU session resource modify request message.

Some examples of the method, first radio access networks (RANs), and non-transitory computer-readable medium described herein may further include operations, features, means, or instructions for transmitting a second indication of the FEC content ratio to a centralized unit-user plane (CU-UP) associated with the first RAN node via an E1 interface, where the second indication may be included in a bearer context setup request message or a bearer context modification request message.

Some examples of the method, first radio access networks (RANs), and non-transitory computer-readable medium described herein may further include operations, features, means, or instructions for transmitting a second indication of the FEC content ratio to the DU via an F1 interface, where the second indication may be included in a user equipment (UE) context setup request message or a UE context modification request message.

In some examples of the method, first radio access networks (RANs), and non-transitory computer-readable medium described herein, the first RAN node may be a source CU-CP and the method, apparatuses, and non-transitory computer-readable medium may include further operations, features, means, or instructions for transmitting a second indication of the FEC content ratio to a target CU-CP via an Xn interface, where the second indication may be included in a handover request message or a retrieve UE context response message.

Some examples of the method, first radio access networks (RANs), and non-transitory computer-readable medium described herein may further include operations, features, means, or instructions for receiving, from a centralized unit-user plane (CU-UP) associated with the first RAN node, a second indication of the discarded PDUs of the one or more PDU sets, where the second indication may be per PDU set.

In some examples of the method, first radio access networks (RANs), and non-transitory computer-readable medium described herein, the discarded PDUs include one or more of radio link control (RLC) PDUs discarded from an RLC transmission buffer of the DU, RLC PDUs discarded from an RLC retransmission buffer of the DU, segments of RLC PDUs discarded from the RLC retransmission buffer of the DU, medium access control (MAC) PDUs discarded from a hybrid automatic repeat request (HARQ) retransmission buffer of the DU, or a combination thereof.

In some examples of the method, first radio access networks (RANs), and non-transitory computer-readable medium described herein, the second indication includes a PDU set sequence number associated with a PDU set of the one or more PDU sets, a number of discarded PDUs from the PDU set, a PDU sequence number associated with each of the discarded PDUs from the PDU set, or combinations thereof.

In some examples of the method, first radio access networks (RANs), and non-transitory computer-readable medium described herein, the second indication may be received over a New Radio (NR) interface via a downlink data delivery status message or a downlink data FEC status message.

Some examples of the method, first radio access networks (RANs), and non-transitory computer-readable medium described herein may further include operations, features, means, or instructions for transmitting, to the DU, a third indication of activation of FEC reporting, where the second indication of the discarded PDUs may be received based on the third indication.

In some examples of the method, first radio access networks (RANs), and non-transitory computer-readable medium described herein, the third indication may be transmitted to the DU via an F1 interface and may be included in a UE context setup request message or a UE context modification request message.

Some examples of the method, first radio access networks (RANs), and non-transitory computer-readable medium described herein may further include operations, features, means, or instructions for transmitting, to a centralized unit-user plane (CU-UP) associated with the first RAN node, a second indication of an FEC measurement and reporting configuration associated with a UE associated with the QoS flow.

In some examples of the method, first radio access networks (RANs), and non-transitory computer-readable medium described herein, the second indication may be transmitted via an F1 interface and may be included in a bearer context setup request message or a bearer context modification request message.

Some examples of the method, first radio access networks (RANs), and non-transitory computer-readable medium described herein may further include operations, features, means, or instructions for receiving, from the CU-UP, a third indication of a suggested FEC content ratio for inclusion in the FEC report.

Some examples of the method, first radio access networks (RANs), and non-transitory computer-readable medium described herein may further include operations, features, means, or instructions for receiving, from the CU-UP, a third indication of an FEC measurement report in accordance with the FEC measurement and reporting configuration, where the FEC measurement report includes one or more of a QoS flow identifier associated with the QoS flow, a total number of PDUs since a last FEC measurement report, a ratio of discarded PDUs to a total number of PDUs since a last FEC measurement report, a suggested FEC content ratio, or discarded PDU set information, and where the discarded PDU set information includes, for each PDU set included in the discarded PDU set information, a PDU set sequence number associated with the PDU set and a ratio of discarded PDUs from the PDU set to a total number of PDUs in the PDU set, where the discarded PDU set information may be based on discarded PDUs at the DU and on one or more PDUs remaining in a buffer of the CU-UP.

In some examples of the method, first radio access networks (RANs), and non-transitory computer-readable medium described herein, the third indication may be received via an E1 interface and may be included in a downlink data notification message, a data usage report message or a UE measurement report message.

Some examples of the method, first radio access networks (RANs), and non-transitory computer-readable medium described herein may further include operations, features, means, or instructions for receiving, from the SMF, a second indication of an FEC measurement and reporting configuration associated with a UE associated with the QoS flow.

In some examples of the method, first radio access networks (RANs), and non-transitory computer-readable medium described herein, the second indication may be received via an NG interface and may be included in a measurement configuration request message, a PDU session resource setup request message, or a PDU session resource modify request message.

Some examples of the method, first radio access networks (RANs), and non-transitory computer-readable medium described herein may further include operations, features, means, or instructions for determining, for each PDU set of the one or more PDU sets and based on discarded PDUs indicated in one or more FEC reports received from the DU or on one or more PDUs remaining in a buffer of the CU-CP, discarded PDU information.

In some examples of the method, first radio access networks (RANs), and non-transitory computer-readable medium described herein, the FEC report may be transmitted to the SMF and includes one or more of a QoS flow identifier associated with the QoS flow, a total number of PDUs since a last FEC measurement report, a ratio of discarded PDUs to a total number of PDUs since a last FEC measurement report, a suggested FEC content ratio, or discarded PDU set information and the discarded PDU set information includes, for each PDU set included in the discarded PDU information, a PDU set sequence number associated with the PDU set and a ratio of discarded PDUs from the PDU set to a total number of PDUs in the PDU set.

In some examples of the method, first radio access networks (RANs), and non-transitory computer-readable medium described herein, the FEC report may be transmitted via an NG interface and the FEC report may be included in a measurement report message.

In some examples of the method, first radio access networks (RANs), and non-transitory computer-readable medium described herein, the first RAN node includes a centralized unit-user plane (CU-UP) and the method, apparatuses, and non-transitory computer-readable medium may include further operations, features, means, or instructions for determining, for each PDU set of the one or more PDU sets and based on discarded PDUs indicated in one or more FEC reports received from the DU or on one or more PDUs remaining in a buffer of the CU-UP, discarded PDU information.

In some examples of the method, first radio access networks (RANs), and non-transitory computer-readable medium described herein, the FEC report may be transmitted to a user plane function (UPF) of a core network, based on the discarded PDU information, and via an uplink PDU session information frame of a PDU session user plane protocol, the FEC report includes one or more of a total number of PDUs since a last FEC measurement report, a ratio of discarded PDUs to a total number of PDUs since a last FEC measurement report, a suggested FEC content ratio, and PDU set information, and the PDU set information includes, for each PDU set included in the discarded PDU information, a PDU set sequence number associated with the PDU set and a ratio of discarded PDUs from the PDU set to a total number of PDUs in the PDU set.

Some examples of the method, first radio access networks (RANs), and non-transitory computer-readable medium described herein may further include operations, features, means, or instructions for updating one or more QoS monitoring parameters to include information associated with the discarded PDUs.

Some examples of the method, first radio access networks (RANs), and non-transitory computer-readable medium described herein may further include operations, features, means, or instructions for receiving, from an application function (AF) associated with a core network associated with the first RAN node, a request for measurements associated with at least one of the one or more QoS monitoring parameters.

A method for wireless communications by a UE is described. The method may include transmitting a request to receive a data traffic flow, where the data traffic flow includes one or more packet data unit (PDU) sets associated with a quality of service (QoS) flow and receiving at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

A UE for wireless communications is described. The UE may include one or more memories storing processor executable code, and one or more processors coupled with the one or more memories. The one or more processors may individually or collectively be operable to execute the code to cause the UE to transmit a request to receive a data traffic flow, where the data traffic flow includes one or more packet data unit (PDU) sets associated with a quality of service (QoS) flow and receive at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

Another UE for wireless communications is described. The UE may include means for transmitting a request to receive a data traffic flow, where the data traffic flow includes one or more packet data unit (PDU) sets associated with a quality of service (QoS) flow and means for receiving at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

A non-transitory computer-readable medium storing code for wireless communications is described. The code may include instructions executable by one or more processors to transmit a request to receive a data traffic flow, where the data traffic flow includes one or more packet data unit (PDU) sets associated with a quality of service (QoS) flow and receive at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

In some examples of the method, user equipment (UEs), and non-transitory computer-readable medium described herein, a portion of PDUs of the one or more PDU sets may be not received at the UE based on the at least one PDU satisfying the FEC content ratio for the PDU set of the one or more PDU sets.

Some examples of the method, user equipment (UEs), and non-transitory computer-readable medium described herein may further include operations, features, means, or instructions for transitioning into a sleep mode based on non-receipt of the portion of the one or more PDU sets.

A method for wireless communications by a first radio access network (RAN) node is described. The method may include receiving, from a second node and via an interface, a first indication of a capability of a core network to support packet data unit (PDU) set information marking, transmitting, to the second node and via the interface, based on the capability of the core network, a PDU set information marking request associated with a data traffic flow between the second node and a UE, where the data traffic flow includes one or more PDU sets associated with a quality of service (QoS) flow, and receiving the data traffic with PDU set information marking, responsive to the PDU set information marking request and independent of whether a PDU set quality of service (QoS) configuration is associated with the QoS flow.

A first radio access network (RAN) node for wireless communications is described. The first radio access network (RAN) node may include one or more memories storing processor executable code, and one or more processors coupled with the one or more memories. The one or more processors may individually or collectively be operable to execute the code to cause the first radio access network (RAN) node to receive, from a second node and via an interface, a first indication of a capability of a core network to support packet data unit (PDU) set information marking, transmit, to the second node and via the interface, based on the capability of the core network, a PDU set information marking request associated with a data traffic flow between the second node and a UE, where the data traffic flow includes one or more PDU sets associated with a quality of service (QoS) flow, and receive the data traffic with PDU set information marking, responsive to the PDU set information marking request and independent of whether a PDU set quality of service (QoS) configuration is associated with the QoS flow.

Another first radio access network (RAN) node for wireless communications is described. The first radio access network (RAN) node may include means for receiving, from a second node and via an interface, a first indication of a capability of a core network to support packet data unit (PDU) set information marking, means for transmitting, to the second node and via the interface, based on the capability of the core network, a PDU set information marking request associated with a data traffic flow between the second node and a UE, where the data traffic flow includes one or more PDU sets associated with a quality of service (QoS) flow, and means for receiving the data traffic with PDU set information marking, responsive to the PDU set information marking request and independent of whether a PDU set quality of service (QoS) configuration is associated with the QoS flow.

A non-transitory computer-readable medium storing code for wireless communications is described. The code may include instructions executable by one or more processors to receive, from a second node and via an interface, a first indication of a capability of a core network to support packet data unit (PDU) set information marking, transmit, to the second node and via the interface, based on the capability of the core network, a PDU set information marking request associated with a data traffic flow between the second node and a UE, where the data traffic flow includes one or more PDU sets associated with a quality of service (QoS) flow, and receive the data traffic with PDU set information marking, responsive to the PDU set information marking request and independent of whether a PDU set quality of service (QoS) configuration is associated with the QoS flow.

In some examples of the method, first radio access networks (RANs), and non-transitory computer-readable medium described herein, the PDU set information marking may be used by the first RAN node in determination of whether the first RAN node may be to forward individual ones of the one or more PDU sets to the UE.

In some examples of the method, first radio access networks (RANs), and non-transitory computer-readable medium described herein, the PDU set information marking request includes a PDU set information marking value that indicates activation or deactivation of PDU set information marking.

In some examples of the method, first radio access networks (RANs), and non-transitory computer-readable medium described herein, the PDU set information marking value may be included in a single bit information element of a second message.

In some examples of the method, first radio access networks (RANs), and non-transitory computer-readable medium described herein, the interface may be a next generation (NG) interface and the second node may be an access and mobility management function (AMF) of the core network.

In some examples of the method, first radio access networks (RANs), and non-transitory computer-readable medium described herein, the first indication may be included in a PDU session resource setup request message, a PDU session resource modify request message, or a path switch request acknowledge message and the second indication may be included in a PDU session resource setup response message, a PDU session resource modify response message, a PDU session resource modify indication message, a PDU session resource notify message, or a path switch request message.

In some examples of the method, first radio access networks (RANs), and non-transitory computer-readable medium described herein, the first indication may be included in a first message at a QoS flow level or at a PDU session level, and the PDU set information marking request may be included in a second message at the QoS flow level or at the PDU session level.

In some examples of the method, first radio access networks (RANs), and non-transitory computer-readable medium described herein, the interface includes an E1 interface and the first RAN node includes a centralized unit-user plane (CU-UP) and the second node includes a centralized unit-control plane (CU-CP) associated with the first RAN node.

In some examples of the method, first radio access networks (RANs), and non-transitory computer-readable medium described herein, the first indication may be included in a bearer context setup request message or a bearer context modification request message and the second indication may be included a bearer context setup response message, a bearer context modification response message, or a bearer context modification required message.

In some examples of the method, first radio access networks (RANs), and non-transitory computer-readable medium described herein, the second indication may be included in a CU-UP status indication message that includes one or more UE identifiers associated with the PDU set information marking request.

In some examples of the method, first radio access networks (RANs), and non-transitory computer-readable medium described herein, the first indication may be included in a first message at a QoS flow level, at a bearer level or at a PDU session level, and the PDU set information marking request may be included in a second message at the QoS flow level, at the bearer level, or at the PDU session level.

In some examples of the method, first radio access networks (RANs), and non-transitory computer-readable medium described herein, the interface includes an F1 interface and the first RAN node includes a distributed unit (DU) and the second node includes a centralized unit (CU) associated with the first RAN node.

In some examples of the method, first radio access networks (RANs), and non-transitory computer-readable medium described herein, the first indication may be included in a UE context setup request message or a UE context modification request message and the second indication may be included in a UE context setup response message, a UE context modification response message, a UE context modification required message, or a notify message.

In some examples of the method, first radio access networks (RANs), and non-transitory computer-readable medium described herein, the first indication may be included in a first message at a QoS flow level or at a data radio bearer (DRB) level, and the PDU set information marking request may be included in a second message at the QoS flow level or at the DRB level.

In some examples of the method, first radio access networks (RANs), and non-transitory computer-readable medium described herein, the second indication may be included in a distributed unit (DU) status indication message that includes one or more UE identifiers associated with the PDU set information marking request.

In some examples of the method, first radio access networks (RANs), and non-transitory computer-readable medium described herein, the interface includes an Xn interface.

In some examples of the method, first radio access networks (RANs), and non-transitory computer-readable medium described herein, the first RAN node may be a target RAN node and the second node may be a source RAN node and the first indication may be included in a handover request message.

In some examples of the method, first radio access networks (RANs), and non-transitory computer-readable medium described herein, the second node may be a future RAN node that may be to replace the first RAN node in communication with the UE and the first indication may be included in a retrieve UE context response message.

In some examples of the method, first radio access networks (RANs), and non-transitory computer-readable medium described herein, the first indication may be included in a first message at a QoS flow level or at a PDU session level, and the PDU set information marking request may be included in a second message at the QoS flow level or at the PDU session level.

In some examples of the method, first radio access networks (RANs), and non-transitory computer-readable medium described herein, the first RAN node may be a secondary RAN node and the second node may be a master RAN node and the UE may be in dual connectivity with the master RAN node and the secondary RAN node.

In some examples of the method, first radio access networks (RANs), and non-transitory computer-readable medium described herein, the first indication may be included in a secondary node (S-Node) addition request message or an S-Node modification request message and the second indication may be included in a S-Node addition request acknowledge message, an S-Node modification request acknowledge message, and S-Node modification required message, or an activity notification message.

In some examples of the method, first radio access networks (RANs), and non-transitory computer-readable medium described herein, the first indication may be included in a first message at a QoS flow level or at a data radio bearer (DRB) level, and the PDU set information marking request may be included in a second message at the QoS flow level or at the DRB level.

In some examples of the method, first radio access networks (RANs), and non-transitory computer-readable medium described herein, the first indication may be included in a resource status request message and the second indication may be included in a resource status update message that includes one or more UE identifiers associated with the PDU set information marking request.

In some examples of the method, first radio access networks (RANs), and non-transitory computer-readable medium described herein, the first RAN node includes a distributed unit (DU) and the second node includes a centralized unit user-plane (CU-UP) associated with the first RAN node and the second indication may be included in a user plane protocol assistance information data message.

In some examples of the method, first radio access networks (RANs), and non-transitory computer-readable medium described herein, the first RAN node and the second node may be in dual connectivity operation with the UE, the second node hosts packet data convergence protocol (PDCP) during the dual connectivity operation, and the second indication may be included in a user plane protocol assistance information data message.

In some examples of the method, first radio access networks (RANs), and non-transitory computer-readable medium described herein, the first RAN node includes a centralized unit-user plane (CU-UP) and the second node includes a user plane function (UPF) of the core network and the second indication may be included in an uplink PDU session information message or downlink PDU set information marking request message.

In some examples of the method, first radio access networks (RANs), and non-transitory computer-readable medium described herein, the downlink PDU set information marking request message includes a marking request indicator and a marking request and the marking request indicator indicates whether the marking request may be present.

In some examples of the method, first radio access networks (RANs), and non-transitory computer-readable medium described herein, PDU set QoS parameters may be not configured for the QoS flow.

Some examples of the method, first radio access networks (RANs), and non-transitory computer-readable medium described herein may further include operations, features, means, or instructions for receiving, from the core network, a configuration of one or more PDU set QoS parameters, where the PDU set QoS parameters include a PDU set delay budget parameter, a PDU set error rate parameter, a PDU set integrated handling information indicator, or any combination thereof.

Some examples of the method, first radio access networks (RANs), and non-transitory computer-readable medium described herein may further include operations, features, means, or instructions for transmitting a QoS report for the data traffic flow on a per PDU set basis, where the QoS report includes one or more of the PDU set QoS parameters.

A method for wireless communications by a UE is described. The method may include transmitting a request to receive a data traffic flow, where the data traffic flow includes one or more packet data unit (PDU) sets associated with a quality of service (QoS) flow and receiving, via a radio access network (RAN) node and independent of whether a PDU set quality of service (QoS) configuration is associated with the QoS flow, at least one PDU set of the one or more PDU sets in accordance with a PDU set importance parameter included in PDU set information marking.

A UE for wireless communications is described. The UE may include one or more memories storing processor executable code, and one or more processors coupled with the one or more memories. The one or more processors may individually or collectively be operable to execute the code to cause the UE to transmit a request to receive a data traffic flow, where the data traffic flow includes one or more packet data unit (PDU) sets associated with a quality of service (QoS) flow and receive, via a radio access network (RAN) node and independent of whether a PDU set quality of service (QoS) configuration is associated with the QoS flow, at least one PDU set of the one or more PDU sets in accordance with a PDU set importance parameter included in PDU set information marking.

Another UE for wireless communications is described. The UE may include means for transmitting a request to receive a data traffic flow, where the data traffic flow includes one or more packet data unit (PDU) sets associated with a quality of service (QoS) flow and means for receiving, via a radio access network (RAN) node and independent of whether a PDU set quality of service (QoS) configuration is associated with the QoS flow, at least one PDU set of the one or more PDU sets in accordance with a PDU set importance parameter included in PDU set information marking.

A non-transitory computer-readable medium storing code for wireless communications is described. The code may include instructions executable by one or more processors to transmit a request to receive a data traffic flow, where the data traffic flow includes one or more packet data unit (PDU) sets associated with a quality of service (QoS) flow and receive, via a radio access network (RAN) node and independent of whether a PDU set quality of service (QoS) configuration is associated with the QoS flow, at least one PDU set of the one or more PDU sets in accordance with a PDU set importance parameter included in PDU set information marking.

In some examples of the method, user equipment (UEs), and non-transitory computer-readable medium described herein, a portion of PDU sets of the one or more PDU sets may be not received at the UE based on the PDU set importance parameter.

In some examples of the method, user equipment (UEs), and non-transitory computer-readable medium described herein, the PDU set information marking includes, for each PDU set, a PDU set sequence number, an indication of an end PDU, a PDU sequence number within a respective PDU set, a PDU set size, the PDU set importance parameter, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example of a wireless communications system that supports techniques for radio access network (RAN) signaling for forward error correction (FEC) awareness and packet data unit (PDU) set information marking in accordance with one or more aspects of the present disclosure.

FIG. 1B shows an example of a network architecture that supports ran signaling for FEC awareness and PDU set information marking in accordance with one or more aspects of the present disclosure.

FIG. 2 shows an example of a portion of a wireless communications system that supports techniques for RAN signaling for FEC awareness and PDU set information marking in accordance with one or more aspects of the present disclosure.

FIG. 3 shows an example of a signal flow that supports techniques for RAN signaling for PDU set information marking in accordance with one or more aspects of the present disclosure.

FIG. 4 shows an example of a signal flow that supports techniques for RAN signaling for FEC awareness in accordance with one or more aspects of the present disclosure.

FIG. 5 shows examples of next generation (NG) interface signal flows that support techniques for RAN signaling for FEC awareness and PDU set information marking in accordance with one or more aspects of the present disclosure.

FIG. 6 shows examples of E1 interface signal flows that support techniques for RAN signaling for FEC awareness and PDU set information marking in accordance with one or more aspects of the present disclosure.

FIG. 7 shows examples of F1 interface signal flows that support techniques for RAN signaling for FEC awareness and PDU set information marking in accordance with one or more aspects of the present disclosure

FIGS. 8 and 9 show examples of Xn interface signal flows that support techniques for RAN signaling for FEC awareness and PDU set information marking in accordance with one or more aspects of the present disclosure.

FIG. 10 shows examples of signal flows that support techniques for RAN signaling for FEC awareness and PDU set information marking in accordance with one or more aspects of the present disclosure.

FIGS. 11 and 12 show block diagrams of devices that support techniques for RAN signaling for FEC awareness and PDU set information marking in accordance with one or more aspects of the present disclosure.

FIG. 13 shows a block diagram of a communications manager that supports techniques for RAN signaling for FEC awareness and PDU set information marking in accordance with one or more aspects of the present disclosure.

FIG. 14 shows a diagram of a system including a device that supports techniques for RAN signaling for FEC awareness and PDU set information marking in accordance with one or more aspects of the present disclosure.

FIGS. 15 and 16 show block diagrams of devices that support techniques for RAN signaling for FEC awareness and PDU set information marking in accordance with one or more aspects of the present disclosure.

FIG. 17 shows a block diagram of a communications manager that supports techniques for RAN signaling for FEC awareness and PDU set information marking in accordance with one or more aspects of the present disclosure.

FIG. 18 shows a diagram of a system including a device that supports techniques for RAN signaling for FEC awareness and PDU set information marking in accordance with one or more aspects of the present disclosure.

FIGS. 19 through 22 show flowcharts illustrating methods that support techniques for RAN signaling for FEC awareness and PDU set information marking in accordance with one or more aspects of the present disclosure.

### DETAILED DESCRIPTION

Wireless communication systems may transmit and receive various types of data, such as voice, video, images, messaging, etc., over a wireless network. The various types of data may have varying system requirements for bandwidth, latency, packet loss, priority, or the like. As such, wireless communication systems may utilize various quality of service (QoS) mechanisms to manage and ensure performance and reliability, and to prioritize different types of data traffic over the wireless network. Some wireless communications systems may bundle one or more packet data units (PDUs) into groups or sets for transmission efficiency. The one or more PDUs in a PDU set may carry a payload of a unit of information generated at approximately the same time at an application layer. For instance, the unit of information may be a unit of media information, such as frames or video slides for extended reality (XR) services. The PDUs that belong to a PDU set may be determined by a PDU session anchor (PSA) user plane function (UPF) of a core network of the wireless communication system. The PSA UPF may additionally identify PDU set information associated with each PDU set and include the PDU set information in a general packet radio service (GPRS) tunneling protocol-user plane (GTP-U) header of each of the PDUs for sending to a radio access network (RAN) node, such as a gNB, a base station, a network entity, or the like. The PDU set information may relate to characteristics of the PDU set, such as a sequence number of the PDU set, sequence numbers of PDUs within the PDU set, an indication of an end PDU of the PDU set, a size of the PDU set, an indication of an importance or the PDU set, or the like. Such marking of the PDUs with the PDU set information may enable the RAN node to utilize the PDU set importance indication to make scheduling decisions (e.g., with a QoS flow) regarding whether to discard PDUs at the PDU set level. For instance, the RAN node may determine to discard one or more PDU sets when congestion is detected. In some cases, wireless communications systems that support PDU set information marking may also support PDU set-based QoS handling, such that configuration and reporting of one or more QoS parameters may be at a PDU set level.

However, in some wireless communications systems, PDU set QoS configuration and PDU set information marking may be tightly coupled, such that one may not be provided without the other. For instance, the UPF may in some cases not identify the PDU set information and may not perform the PDU set information marking. This may occur if, for example, an application function (AF) of the core network does not configure PDU set QoS for a particular service flow or if, as another example, the RAN node does not accept a QoS configuration for a service flow from the core network. However, although the RAN node might not be configured for PDU set QoS, it may still be beneficial for the RAN node to receive the PDU set information marking so that the RAN node may be able to discard PDUs based on importance in the event of congestion.

In accordance with aspects described herein, PDU set information marking may be decoupled from PDU set QoS configuration. To enable the decoupling, the core network may send an indication to the RAN node of a capability to support downlink PDU set information marking. Based on receiving the capability indication, the RAN node may request that the core network perform the PDU set information marking.

Some wireless communications systems also support application forward error correction (FEC). FEC may refer to a technique of transmitting (e.g., by an application) additional packets beyond what is required for a receiver (e.g., a user equipment (UE)) to be able to decode the data, such that the receiver is able to reconstruct the content of the data from a subset of the packets received at the receiver. Such techniques may minimize the need for retransmissions of data from the application to the UE. In accordance with these techniques, a RAN node may forward application data, such as a video frame, that may include one or more PDU sets (in some cases, referred to as application data units (ADUs)). The PDU sets may include a number (e.g., quantity) of source symbols that correspond to original packets (e.g., packets for the video frame) and a number (e.g., quantity) of repair symbols that correspond to additional packets. For example, there may be K original packets corresponding to the video frame. The additional repair packets may be packaged together in the PDU set, with the K original packets, for a total of N packets. However, the receiver, e.g., the UE, may be able reconstruct the video frame if any K out of the N packets are successfully received. In this case, once the UE has successfully received K packets (e.g., any K packets) from the PDU set, the RAN node may not need to transmit remaining packets (e.g., obsolete packets) of the PDU set (e.g., packets remaining in a buffer of the RAN node) to the UE. Additionally, once the UE has received all of the packets needed to reconstruct the video frame, the RAN need not send the obsolete packets and the UE may be able to enter into a sleep mode to conserver power until additional packets are transmitted to the UE.

However, in some wireless communications systems, a RAN node may not be aware of when the receiver has received a sufficient number of packets such that the receiver can successfully reconstruct the underlying content. Accordingly, it may be beneficial for the RAN node to be aware of a ratio of repair packets (e.g., N-K) to the total number of packets (e.g., N) in a PDU set, referred to as a FEC content ratio. In some cases, the FEC content ratio may be in the range of 30-50%, thus, a significant savings in air interface resources and power consumption may be achieved if the RAN node does not need to send and the UE does not need to receive all N packets.

In accordance with aspects described herein, the RAN node may be notified as to whether an application applies FEC. For instance, the core network may signal to the RAN node an indication of a whether FEC is applied and, if so, a corresponding FEC content ratio. In some cases, the FEC content ratio may be associated with a QoS flow. The RAN node may, thereafter, discard one or more obsolete PDUs once the FEC content ratio is satisfied by the receiver (e.g., not send the obsolete PDUs to the receiver). The RAN node may additionally report, to the core network, a number (e.g., a quantity) of PDUs that are discarded as a result of FEC content ratio being satisfied.

Aspects of the disclosure are initially described in the context of wireless communications systems. Aspects of the disclosure are further illustrated by and described with reference to apparatus diagrams, system diagrams, and flowcharts that relate to techniques for RAN signaling for FEC awareness and PDU set information marking.

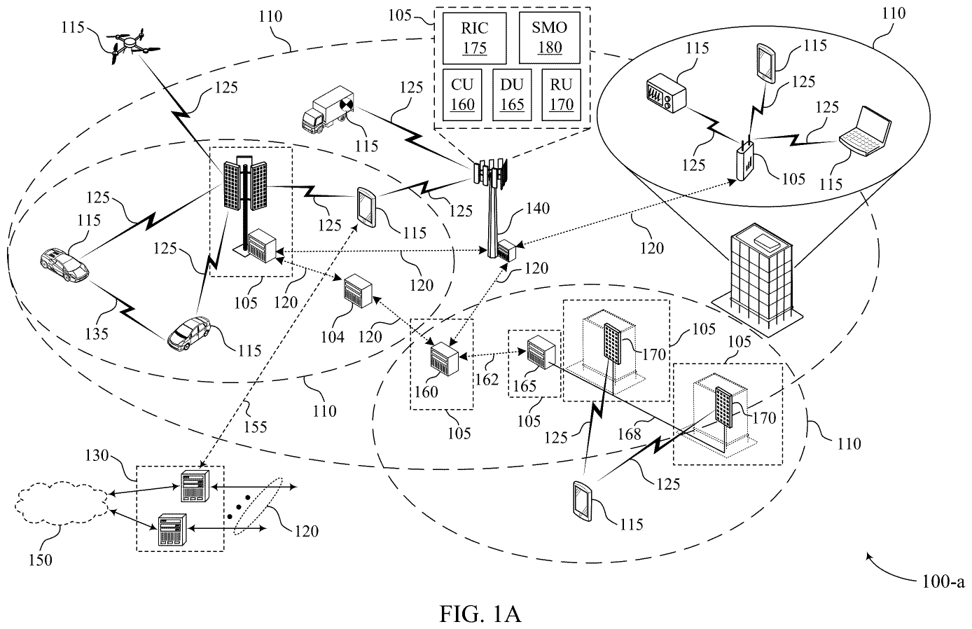

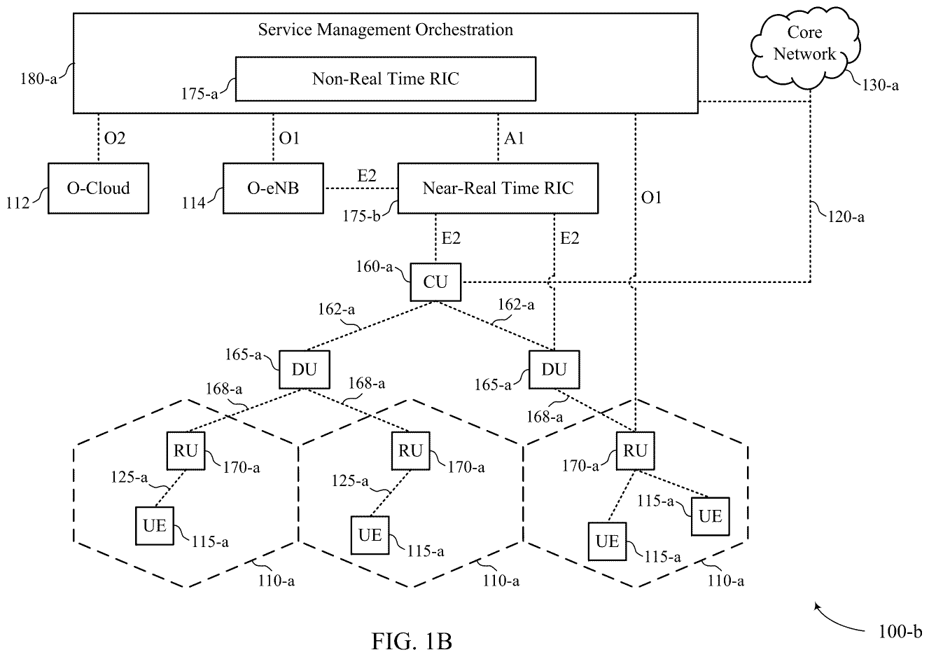

FIG. 1A shows an example of a wireless communications system 100-a that supports techniques for RAN signaling for FEC awareness and PDU set information marking in accordance with one or more aspects of the present disclosure. The wireless communications system 100-a may include one or more devices, such as one or more network devices (e.g., network entities 105), one or more UEs 115, and a core network 130. In some examples, the wireless communications system 100-a may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100-a and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100-a, and each UE 115 may be stationary, or mobile, or both at different times. The UEs 115 may be devices in different forms or having different capabilities. Some example UEs 115 are illustrated in FIG. 1A. The UEs 115 described herein may be capable of supporting communications with various types of devices in the wireless communications system 100-a (e.g., other wireless communication devices, including UEs 115 or network entities 105), as shown in FIG. 1A.

As described herein, a node of the wireless communications system 100-a, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100-a), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for RAN signaling for FEC awareness and PDU set information marking as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1A.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100-a may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100-a, a slot may further be divided into multiple mini-slots associated with one or more symbols. Excluding the cyclic prefix, each symbol period may be associated with one or more (e.g., N_{f}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100-a and may be referred to as a transmission time interval (TTI). In some examples, the TTI duration (e.g., a quantity of symbol periods in a TTI) may be variable. Additionally, or alternatively, the smallest scheduling unit of the wireless communications system 100-a may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100-a may include, for example, a heterogeneous network in which different types of the network entities 105 support communications for coverage areas 110 (e.g., different coverage areas) using the same or different RATs.

The wireless communications system 100-a may be configured to support ultra-reliable communications or low-latency communications, or various combinations thereof. For example, the wireless communications system 100-a may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100-a may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100-a may utilize both licensed and unlicensed RF spectrum bands. For example, the wireless communications system 100-a may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), FEC, and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a core network 130 may receive from a UE 115, such as via a network entity 105 (e.g., a first RAN node) a request for a data traffic flow. The requested data traffic flow may include one or more PDU sets. The network entity 105 may be implemented in a disaggregated architecture (e.g., a disaggregated RAN architecture). For example, the network entity 105 may be physically or logically distributed across, among other entities, a CU 160 and a DU 165. The CU 160 may be further functionally split into a CU-CP and a CU-UP to support control plane and user plane functions, respectively, associated with the CU 160.

In some examples, the core network 130 may transmit to the network entity 105 an indication of a capability to support PDU set information marking. For example, the core network 130 may transmit the capability indication to the CU-CP and the CU-CP of the CU 160 may forward the indication to the CU-UP of the CU 160, which may, in turn, forward the capability indication to the DU 165. Based on receiving the indication, the DU 165 may send a request for PDU set marking of the data traffic flow requested by the UE 115. The DU 165 may send the request to the CU-UP of the CU 160 or to the CU-CP of the CU 160. The CU-UP or the CU-CP may, in turn, forward the request to the core network 130. Based on the request, the core network 130 may perform PDU set information marking of the data traffic flow requested by the UE 115. The network entity 105, such as the DU 165, may receive the data traffic flow with the PDU set information marking and, in some cases, may discard one or more PDU sets included based on the PDU set information marking. For instance, the PDU set information marking may indicate, among other things, an importance associated with each of the PDU sets, and based on congestion, the network entity 105 may discard one or more PDU sets based on the importance indication. After discarding the one or more PDU sets from the data traffic flow, the network entity 105 may send the remaining PDU sets of the data traffic flow to the UE 115.

In some examples, the core network 130 may transmit to the network entity 105 an indication that an application associated with the data traffic flow applies FEC and an indication of a corresponding content ratio. For example, the core network 130 may transmit the FEC content ratio indication to the CU-CP and the CU-CP of the CU 160 may forward the indication to the CU-UP of the CU 160, to the DU 165, or both. The core network 130 may forward the data traffic flow requested by the UE 115 to the network entity 105 and the data traffic flow may include one or more PDU sets that comprise one or more repair packets. The network entity 105, such as the DU 165, may receive the data traffic flow that includes the one or more PDU sets that comprise one or more repair packets and, in some cases, may discard one or more PDU in one or more of the PDUS sets based on determining that an amount of PDUs (e.g., in a given PDU set) received by UE 115 satisfies the FEC content ratio. After discarding the one or more PDUs from one or more of the PDU sets, the network entity 105 may send the remaining PDUs in the one or more PDU sets to the UE 115. The network entity 105, such as the DU 165, may additionally send to the CU-UP a FEC report notifying of the PDUs that were discarded in view of the FEC content ratio being satisfied. The CU-UP may, thereafter, compile information associated with PDUs discarded by the DU as indicated in one or more FEC reports received from the DU, and information associated with any PDUs discarded by the CU-UP. The CU-UP may generate and send to the core network 130 (or to the CU-CP to send to the core network 130) a FEC measurement report that includes the compiled information associated with the PDUs discarded by the DU, the CU-UP, or both. In some cases, the CU-CP may update one or more QoS parameters to include the information associated with the discarded PDUs, and may send to the core network 130 a QoS report including one or more of the QoS parameters.

FIG. 1B shows an example of a network architecture 100-b (e.g., a disaggregated base station architecture, a disaggregated RAN architecture) that supports ran signaling for FEC awareness and PDU set information marking in accordance with one or more aspects of the present disclosure. The network architecture 100-b may illustrate an example for implementing one or more aspects of the wireless communications system 100-a. The network architecture 100-b may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 100-b (e.g., CUs 160-a, DUs 165-a, RUs 170-a, Non-RT RICs 175-a, Near-RT RICs 175-b, SMOs 180-a, Open Clouds (O-Clouds) 112, Open eNBs (O-eNBs) 114) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 112) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 114, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

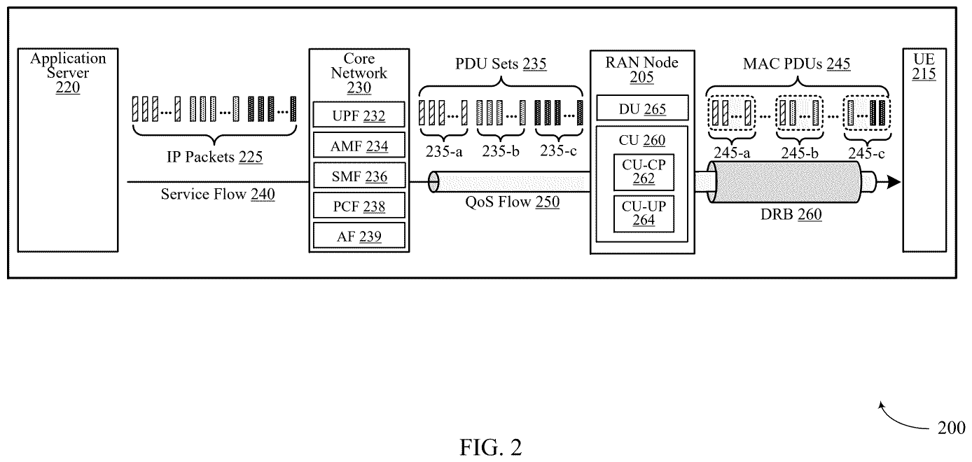

FIG. 2 shows an example of a portion of wireless communications system 200 that supports techniques for RAN signaling for FEC awareness and PDU set information marking in accordance with one or more aspects of the present disclosure. In some cases, the wireless communications system 200 may support or be supported by aspects of the wireless communications system 100-a or the network architecture 100-b described with reference to FIGS. 1A and 1B, respectively. For instance, the wireless communications system 200 may include a core network 230, a network entity, such as a RAN node 205, and a UE 215, which may be examples of core network 130, network entity 105, and UE 115, respectively, described with reference to FIGS. 1A and 1B. The core network 230 may include, among other entities or nodes, a user plane entity, such as a UPF 232, and a control plane entity, such as an AMF 234, a session management function (SMF) 236, a policy control function (PCF) 238, an application function (AF) 239. The UPF 232 and the AMF 234 may be examples of the UPF and the AMF described with reference to FIGS. 1A and 1B. The RAN node 205 may include, among other entities or nodes, a CU 260 and a DU 265, which may be examples of the CU 160 and the DU 165, respectively, described with reference to FIGS. 1A and 1B. The CU 260 may be functionally split into a control plane function, such as a CU-CP 262 and a user plane function, such as a CU-UP 264, which may be examples of the CU-CP and the CU-UP, respectively, described with reference to FIGS. 1A and 1B. The wireless communications system 200 may additionally include an application server 220.

The various entities of the wireless communications system 200 may communicate with one another via one or more communication links 125. In some examples, the communication links 125 may be examples of a Uu link, a sidelink, a backhaul link, a D2D link, an uplink communication link, a downlink communication link, or some other type of communication link 125 described with reference to FIGS. 1A and 1B. Further, in some cases, the RAN node 205 may communicate with other nodes, such as a second node, via one or more interfaces (e.g., an NG interface, an Xn interface, an F1 interface, an E1 interface, or any combination thereof).

In some examples, the UE 215 may receive, from the application server 220 and via the core network 230, the RAN node 205, or both, one or more service flows 240, such as in response to a request from the UE 215 for a data traffic flow associated with a service. For instance, the service may be an XR service, such as a virtual reality (VR) service, an augmented reality (AR) service, a mixed reality (MR) service, or the like. The UE 215 may transmit the request for the data traffic to the application server 220 via the RAN node 205 and the core network 230. In response to the request, the application server 220 may generate a set of IP packets 225 and the set of IP packets 225 may include data, such as text (e.g., messaging) packets, audio packets, video frames, video slices, or the like for the service (e.g., the XR service) corresponding to the requested data traffic. In some cases, the requested service may be multi-modal and the set of IP packets 225 may include multiple different types of data packets.

In some cases, the application server 220 may apply FEC and, as a result, may include, in the set of IP packets 225, one or more additional packets that correspond to repair packets. The repair packets, together with the original packets associated with the data (e.g., packets associated with a video frame), may enable the receiving device, such as the UE 215, to reconstruct the data (e.g., reconstruct the video frame) corresponding to the set of IP packets 225 using a subset of the IP packets 225.

The application server 220 may transmit the set of IP packets 225 to the core network 230 via the one or more service flows 240. The core network 230 may receive the set of IP packets 225 and, in some cases, the UPF 232 of the core network 230 may bundle the IP packets into groups of PDUs to create one or more PDU sets 235. For instance, the UPF 232 may identify one or more PDU sets 235 (e.g., a first PDU set 235-a, a second PDU set 235-b, and a third PDU set 235-c) within the set of IP packets 225. Each PDU set 235 may include one or more PDUs that carry a payload of a single unit of information generated at the application level (e.g., generated by the application server 220). For example, the PDUs may carry or indicate payloads for video frames or audio packets for an XR service associated with the service flow 240. In some cases, one or more of the PDU sets 235 may include a number (e.g., quantity) of source symbols that correspond to original packets (e.g., packets for the video frame) and also a number (e.g., quantity) of repair symbols that correspond to additional packets that enable the UE 215 to reconstruct the data using a subset of the PDUs in the PDU set 235. For example, the first PDU set 235-a may include K original packets corresponding to the video frame and M additional repair packets for a total of N packets. In some cases, the ratio of additional repair packets (e.g., M) to the total quantity of packets (e.g., N) may satisfy a FEC content ratio defined by the application server 220. For instance, 30-50% of the total quantity of packets in a PDU set 235 may be the additional repair packets.

In some examples, each PDU set 235 may be a set of PDUs that are associated with the same type of data, the same service, the same device, or any combination thereof. For example, in some cases, for an XR service, the first PDU set 235-a may be associated with video data, the second PDU set 235-b may be associated with audio data, and the third PDU set 235-c may be associated with text-based data (e.g., chat messages). In another example, for an XR service, the first PDU set 235-a may be associated with a VR Head-Mounted Display (HMD), the second PDU set 235-b may be associated with a pair of VR/AR gloves, and the third PDU set 235-c may be associated with a set of VR/AR glasses. As such, each PDU set 235 may include one or more PDUs associated with the corresponding data type or service.

In some cases, the UPF, (e.g., a PSA UPF) may additionally identify PDU set information associated with each PDU set 235 and include the PDU set information in a GTP-U header of each of the PDUs. In some cases, identifying the PDU set information may be responsive to a request from the RAN node 205 for the PDU set information. The PDU set information may relate to characteristics of a corresponding PDU set 235. For instance, the PDU set information may include a sequence number of the PDU set 235, sequence numbers of PDUs within the PDU set 235, an indication of an end PDU of the PDU set 235, a size of the PDU set 235, an indication of an importance or the PDU set 235, or the like. In accordance with aspects described herein, such marking of the PDUs with the PDU set information may be independent of whether the core network 230 configures the RAN node 205 with a PDU set QoS configuration or whether the RAN node 205 accepts a PDU set QoS configuration from the core network 230. That is, the PDUs may be marked with the PDU set information irrespective of whether the RAN node 205, which is to receive the PDU sets 235, is configured for PDU set-based QoS. Such marking of the PDUs with the PDU set information may enable the RAN node 205, when it receives the PDU sets 235, to utilize the PDU set importance indication included in the PDU set information to make scheduling decisions regarding whether to discard PDUs at the PDU set level, such as whether to discard one or more of the PDU sets 235.

The UPF 232 may further generate one or more QoS flows 250 that include the one or more PDU sets 235 marked with the PDU set information. A QoS flow 250 may be a data traffic flow that is associated with a particular QoS, where the particular QoS may be based on the type of data transmitted in the data traffic flow. The core network 230 may schedule transmission of the one or more QoS flow 250 to the RAN node 205.

The RAN node 205 may receive the one or more QoS flows 250 sent from the core network 230. In some cases, to support the service flow 240 associated with the one or more QoS flows 250 more efficiently, the RAN node 205 may utilize a PDU set-based QoS framework. For instance, the core network 230 may transmit configuration information to the RAN node 205 comprising a PDU set QoS configuration. The PDU set QoS configuration may include one or more PDU set-based QoS parameters, such as a PDU set delay budget (PSDB) parameter, a PDU set error rate (PSER), a PDU set integrated handling information (PSIHI) parameter, among others. In some examples, the RAN node 205 may not receive, from the core network 230, a PDU set QoS configuration for the service flow or may not accept a PDU set QoS configuration received from the core network 230.

The RAN node 205 may package the PDUs from the one or more PDU sets 235 received from the core network 230 into one or more MAC PDUs 245, such as a first MAC PDU 245-a, a second MAC PDU 245-b, and a third MAC PDU 245-c. In some cases, in packaging the one or more MAC PDUs 245, the RAN node 205 may make scheduling decisions regarding transmission of the PDUs and PDU sets 235. For instance, in some cases, the RAN node 205 may determine an order of transmission (e.g., to the UE 215) of the PDUs received in the one or more PDU sets 235. For example, the UE 215 may expect to receive the PDUs in a different order from the order that the RAN node 205 received the PDUs within the one or more PDU sets 235. Thus, the RAN node 205 may may reorder the PDUs when packaging the data into the one or more MAC PDUs 245 for transmission to the UE 215. The RAN node 205 may, thereafter, transmit the one or more MAC PDUs 245 to the UE 215 via a data radio bearer (DRB) 260.

In some cases, before transmitting the MAC PDUs 245 to the UE 215, the RAN node 105 may determine, based on PDU set information associated with the PDUs in the one or more PDU sets 235, to discard one or more of the PDU sets 235. That is, the RAN node 105 may utilize the PDU set importance indication included in the PDU set information to determine whether to discard one or more PDU sets when congestion is detected. For instance, the one or more discarded PDU sets may not be included in the MAC PDUs 245 transmitted to the UE 215.

In some cases, during transmission of the MAC PDUs 245 to the UE 215, the RAN node 205 may determine, based on a FEC content ratio associated with a particular QoS flow 250, to discard one or more PDUs within one or more of the PDU sets 235. That is, the RAN node 105 may determine, when transmitting the PDUs to the UE 215, whether the UE 215 has successfully received, from a given PDU set, an amount of packets (e.g., an amount of PDUs) that satisfies the FEC content ratio. For instance, the RAN node 105 may determine, such as based on feedback (e.g., HARQ feedback) from the UE 215, whether the UE 215 has successfully received at least K packets (e.g., the quantity of original packets) from the PDU set 235. If the UE 215 has received at least K packets (e.g., PDUs) from the PDU set 235, the RAN node 105 may discard one or more obsolete PDUs, such as one or more remaining PDUs (e.g., remaining in a buffer associated with the RAN node 105). For instance, the RAN node 205 may cease transmissions of PDUs from the PDU set 235 and, thus, the discarded PDUs may not be included in the MAC PDUs 245 transmitted to the UE 215.

Accordingly, the UE 215 may receive the one or more MAC PDUs 245 from the RAN node 205 in which PDUs associated with one or more PDU sets 235 have remove, such as based on the PDU set importance indication provided in PDU set information or based on a FEC content ratio being satisfied.

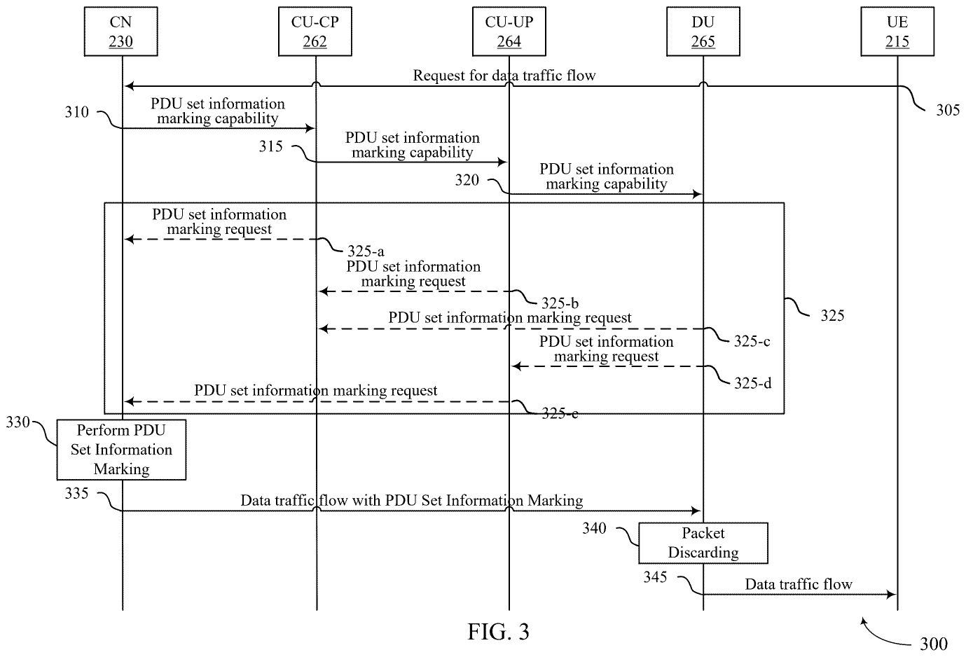

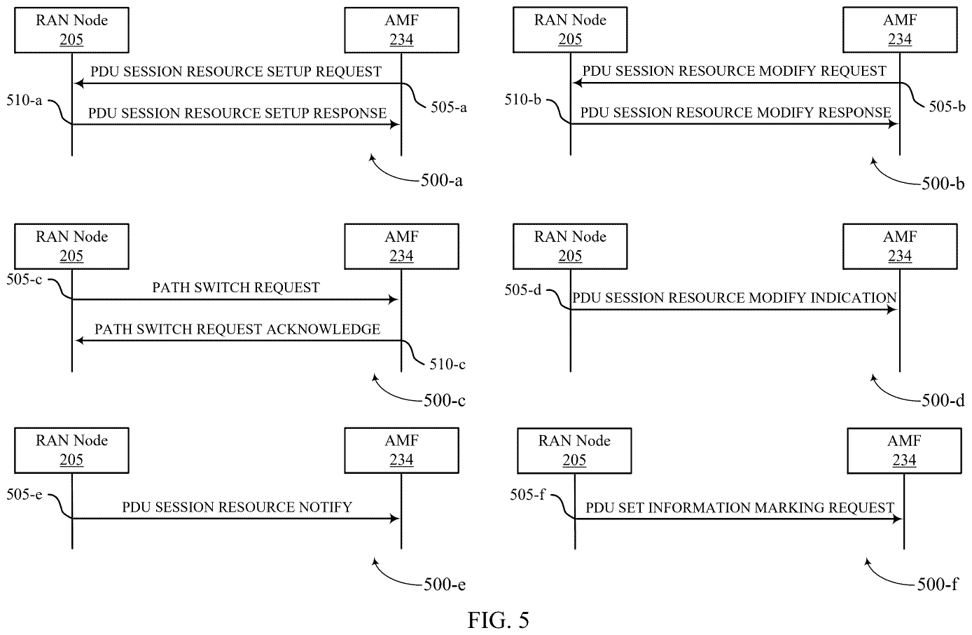

FIG. 3 shows an example of a signal flow 300 that supports techniques for PDU set information marking in accordance with one or more aspects of the present disclosure. In some examples, signal flow 300 may implement aspects of or may be implemented by aspects of wireless communications systems 100-a and 200 and the network architecture 100-b, described with reference to FIGS. 1A, 1B, and 2. Signal flow 300 may be implemented by the core network 230 (including one or more of the UPF 232, AMF 234, and SMF 236 of the core network 230), the RAN node 205 (and one or more of the CU-CP 262, the CU-UP 264, and the DU 265 of the RAN node 205), and the UE 215, described with reference to FIG. 2. In the following description of the signal flow 300, the communications between the various entities or nodes may be performed in different orders or at different times. Some operations may also be omitted from the signal flow 300, and other operations may be added to the signal flow 300. In some examples, the operations illustrated in signal flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added. In some cases, one or more of the signals described with respect to FIG. 3 may communicate information (e.g., an indication, a request, measurements, etc.) that may be included in one or more messages that may be transmitted between entities (e.g., nodes) via one or more interfaces, as described in further detail with respect to FIGS. 5 to 10.

At 305, the UE 215 may transmit (e.g., via the core network 230, the RAN node 205, or both), and the core network 230 may receive, a request for a data traffic flow associated with a service provided by an application server (such as the application server 220 of FIG. 2). For instance, the UE 215 may request a data traffic flow associated with an XR service.

At 310, the core network 230 (e.g., the AMF 234 of the core network 230 of FIG. 2) may transmit, and the CU-CP 262 of the RAN node 205 may receive, an indication of a capability to support PDU set information marking. For example, the core network 230 may signal the capability indication when a PDU session is set up or modified, or during mobility. In this case, the indication of the capability to support PDU set information marking may be included in a message (e.g., in an information element (IE) of the message) that is transmitted via a next generation (NG) interface.

For instance, referring to FIG. 5, the capability indication may be included in a PDU session resource setup request message 505-a of NG interface signal flow 500-a, in a PDU session resource modify request message 505-b of NG interface signal flow 500-b, in a patch switch request acknowledge message 510-c of NG interface signal flow 500-c (e.g., sent in response to a path switch request message 505-c during mobility), or in a combination thereof. In some instances, the indication may be included in the message at a QoS flow level or at a PDU session level.

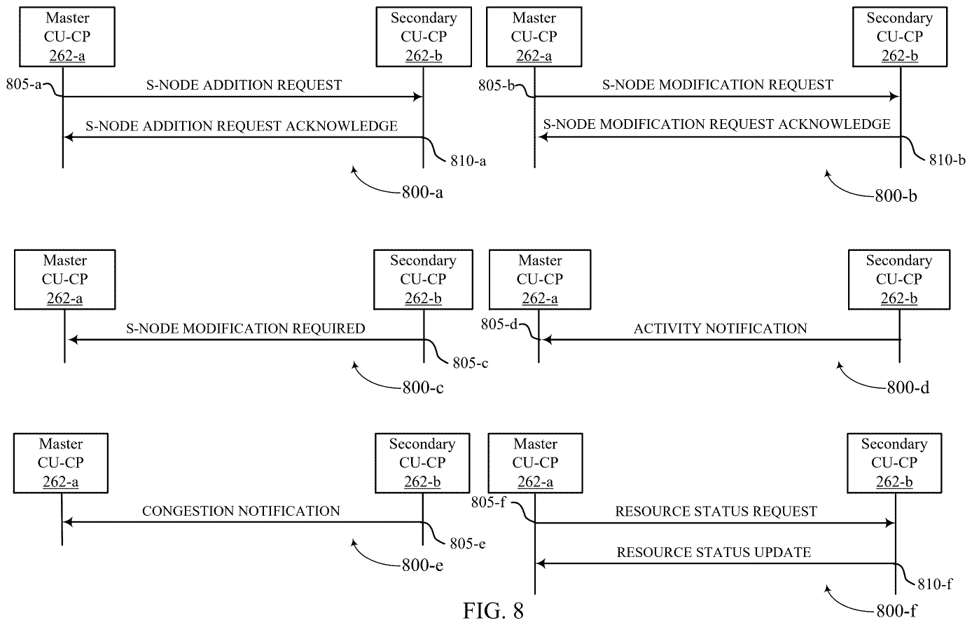

In some examples, the CU-CP 262 of the RAN node 205 may receive an indication of a capability of the core network 230 to support PDU set information marking from a CU-CP associated with another RAN node. For instance, the UE 215 may be configured to operate in dual connectivity with a master RAN node 205-a and with the RAN node 205, where the RAN node 205 may be a secondary RAN node 205-b. In this case, a master RAN node 205-a may signal the capability indication to the secondary RAN node 205-b. That is, a master CU-CP 262-a of the master RAN node 205-a may transmit, and a secondary CU-CP 262-b of the secondary RAN node 205-b may receive, the indication of a capability of the core network 230 to support PDU set information marking. In this case, the indication of the capability to support PDU set information marking may be included in a message (e.g., in an IE of the message) that is transmitted via the Xn interface. For instance, referring to FIG. 8, the capability indication may be included in a secondary node (S-node) addition request message 805-a of Xn interface signal flow 800-a, an S-node modification request message 805-b of Xn interface signal flow 800-b, or a combination thereof. In some instances, the indication may be included in the message at a QoS flow level for secondary node terminated bearers or at the DRB level for master node-terminated bearers.

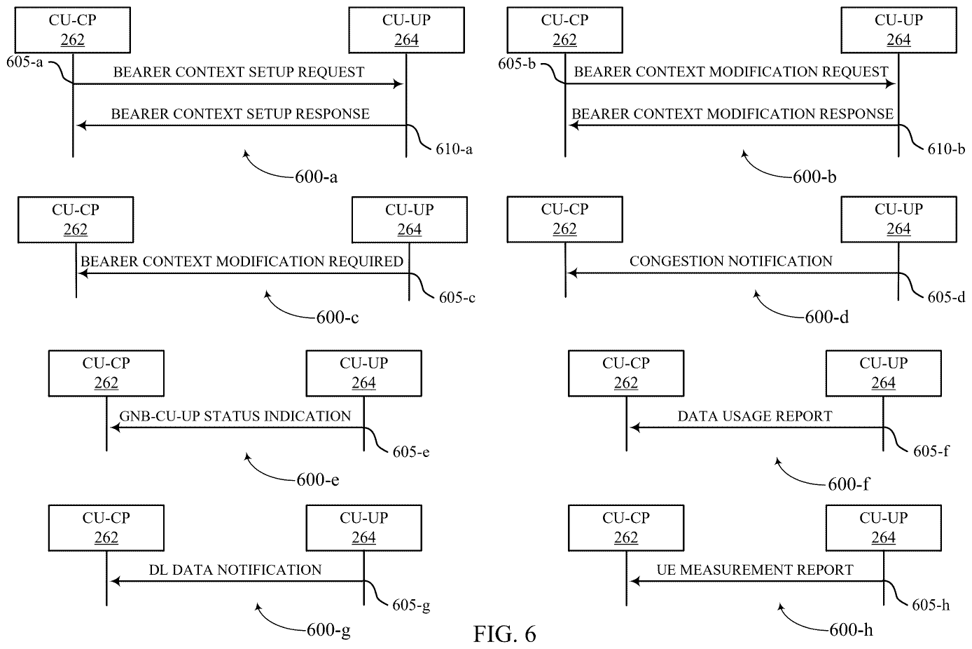

At 315, the CU-CP 262 may forward the capability indication to the CU-UP 264 of the RAN node 205. For instance, the CU-CP 262 may send (e.g., transmit), and the CU-UP 264 may receive, an indication of a capability of the core network 230 to support PDU set information marking. For example, the CU-CP 262 may signal the capability indication when a bearer is setup or modified. In this case, the indication of the capability to support PDU set information marking may be included in a message (e.g., in an IE of the message) that is transmitted via an E1 interface. For instance, referring to FIG. 6, the capability indication may be included in a bearer context setup request message 605-a of E1 interface signal flow 600-a, a bearer context modification request message 605-b of E1 interface signal flow 600-b, or a combination thereof. In some instances, the indication may be included in the message at a QoS flow level, the bearer level, or at a PDU session level.

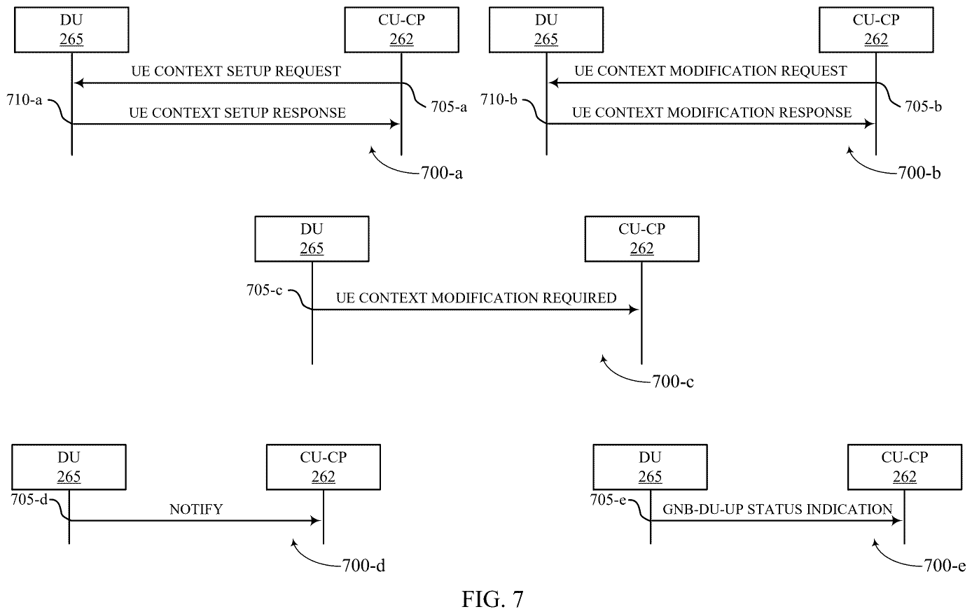

At 320, the CU-CP 262 may forward the capability indication to the DU 265 of the RAN node 205. For instance, the CU-CP 262 may send (e.g., transmit), and the DU 265 may receive, an indication of a capability of the core network 230 to support PDU set information marking. For example, the CU-CP 262 may signal the capability indication when a UE context is setup or modified. In this case, the indication of the capability to support PDU set information marking may be included in a message (e.g., in an IE of the message) that is transmitted via an F1 interface. For instance, referring to FIG. 7, the capability indication may be included in a UE context setup request message 705-a of F1 interface signal flow 700-a, a UE context modification request message 705-b of F1 interface signal flow 700-b, or a combination thereof. In some instances, the indication may be included in the message at a QoS flow level or the DRB level.

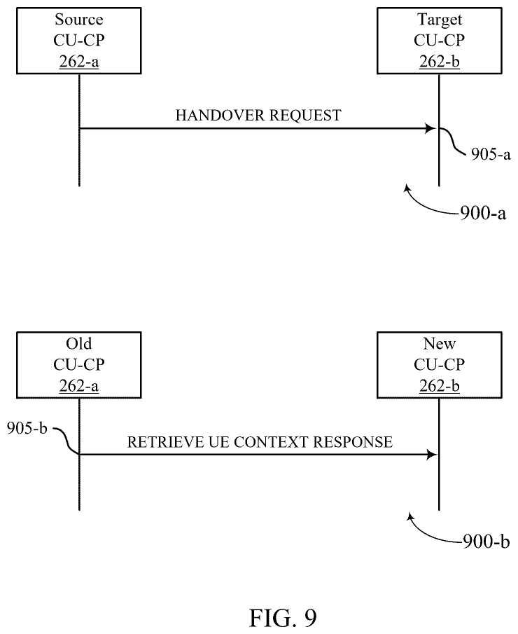

In some examples, the CU-CP 262 of the RAN node 205 may forward the capability indication to a CU-CP associated with another RAN node. For instance, during an Xn handover or during an RRC re-establishment procedure (e.g., during a retrieve UE context procedure), the CU-CP 262 of the RAN node 205 may be a source CU-CP 262-a (or an old CU-CP 262-a) of a source (or old) RAN node 205-a, and the source CU-CP 262-a (or old CU-CP 262-a) may signal the capability indication to a target CU-CP 262-b (or new CU-CP 262-b) of a target (or new) RAN node 205-b. Accordingly, the source CU-CP 262-a (or old CU-CP 262-a) may transmit, and the target CU-CP 262-b (or new CU-CP 262-b) may receive, the indication of a capability of the core network 230 to support PDU set information marking. In this case, the indication of the capability to support PDU set information marking may be included in a message (e.g., in an IE of the message) that is transmitted via an Xn interface. For instance, referring to FIG. 9, the capability indication may be included in a handover request message 905-a of Xn interface signal flow 900-a, a retrieve UE context response message 905-b of Xn interface signal flow 900-b, or a combination thereof. In some instances, the indication may be included in the message at a QoS flow level or the PDU session level.

At 325, in response to the indication of the capability of the core network 230 to support PDU set information marking, the RAN node 205 (e.g., the DU 265, the CU-UP 264, the CU-CP 262, or a combination thereof) may request the core network 230 to perform the PDU set information marking. The request to perform the PDU set information marking may be a request to activate or to deactivate the PDU set information marking. The RAN node 205 may make the request through either control plane signaling or through user plan signaling.

When the RAN node 205 makes the request for the (e.g., activation or deactivation of) PDU set information marking via control plane signaling, the request, or an indication of the request, may be included in a PDU set information marking request IE of a message. In some cases, the PDU set information marking request IE may be an optional single bit IE that indicates, whether the request is for deactivation of the PDU set information marking (e.g., when the IE includes a value of 0), for activation of the PDU set information marking (e.g., when the IE includes a value of 1), or there is no change to the current state of PDU set information marking (e.g., when the IE is empty).

For example, at 325-a, in some cases, the RAN node 205 may signal the request, or an indication of the request, via a message transmitted via the NG interface. In such cases, the PDU set information marking request may be included in a PDU set information marking request IE that is transmitted by the CU-CP 262 of the RAN node 205 to the AMF 234 of the core network 230 via the NG interface. For instance, referring back to FIG. 5, in some examples, the indication of the request (e.g., the PDU set information marking request IE) may be included in a PDU session resource setup response message 510-a of NG interface signal flow 500-a, in a PDU session resource modify response message 510-b of NG interface signal flow 500-b, in a path switch request message 505-c of NG interface signal flow 500-c, in a PDU session resource modify indication message 505-d of NG interface signal flow 500-d, in a PDU session resource notify message 505-e of NG interface signal flow 500-e, in a PDU set information marking request message 505-f of NG interface signal flow 500-f, or in a combination thereof. In some instances, the indication of the request may be included in the message at a QoS flow level or at a PDU session level. In some cases, when the AMF 234 receives the PDU set information marking request, the AMF 234 may communicate (e.g., send) the request to the SMF 236 of the core network 230 and the SMF 236 may communicate the request to the UPF 232 of the core network 230.

At step 325-b, in some cases, the RAN node 205 may signal the request, or an indication of the request, via a message transmitted via the E1 interface. In such cases, the PDU set information marking request may be included in a PDU set information marking request IE that is transmitted by the CU-UP 264 to the CU-CP 262 via the E1 interface. For instance, referring back to FIG. 6, in some examples, the indication of the request (e.g., the PDU set information marking request IE) may be included in a UE-specific message (e.g., such as a message specific to the UE 215), such as a bearer context setup response message 610-a of E1 interface signal flow 600-a, in a bearer context modification response message 610-b of E1 interface signal flow 600-b, in a bearer context modification required message 605-c of E1 interface signal flow 600-c, in a congestion notification message 605-d of E1 interface signal flow 600-d, or a combination thereof. In some cases, the indication of the request may be included in a common message, such as a gNB-CU-UP status indication message 605-e of E1 interface signal flow 600-e. In some cases, the gNB-CU-UP status indication message 605-e may include one or more UE identifiers associated with the PDU set information marking request. For instance, the gNB-CU-UP status indication message 605-e may include a UE identifier associated with the UE 215 among others. In some instances, the indication of the request may be included in the message at a QoS flow level, at the bearer level, or at a PDU session level. Upon receiving the PDU information set marking request, the CU-CP 262 may send the request to the core network 230, such as described with reference to 325-a.

In some examples, the CU-CP 262 of the RAN node 205 may send indication of the PDU set information marking request to a CU-CP associated with another RAN node. For instance, the UE 215 may be configured to operate in dual connectivity with the master RAN node 205-a and with the RAN node 205, where the RAN node 205 may be a secondary RAN node 205-b. In this case, the master RAN node 205-a may configure the secondary RAN node 205-b for the PDU set information marking request. For instance, referring back to FIG. 8, the master RAN node 205-a may transmit the configuration to the secondary RAN node 205-b via a global message, such as a resource status request message 805-f of Xn interface signal flow 800-f. Accordingly, the secondary RAN node 205-b may send an indication of a request for PDU set information marking to the master RAN node 205-a. For instance, the secondary CU-CP 262-b of the secondary RAN node 205-b may transmit, and the master CU-CP 262-a of the master RAN node 205-a may receive, the indication of the request for PDU set information marking. In this case, the indication of the request may be included in a message (e.g., the PDU set information marking request IE) that is transmitted via the Xn interface. For instance, referring back to FIG. 8, in some examples, the indication of the request may be included in a UE-specific message, such as an S-node addition request acknowledge message 810-a of Xn interface signal flow 800-a, in an S-node modification request acknowledge message 810-b of Xn interface signal flow 800-b, in an S-node modification required message 805-c of Xn interface signal flow 800-c, in an activity notification message 805-d of Xn interface signal flow 800-d, or a combination thereof. In some cases, the indication of the request may be included in a global message, such as a congestion notification message 805-e of Xn interface signal flow 800-e. In some cases, the indication of the request may be included in a common message, such as a resource status update message 810-f of Xn interface signal flow 800-f. In some cases, the resource status update message 810-f may include one or more UE identifiers associated with the PDU set information marking request. For instance, the resource status update message 810-f may include a UE identifier associated with the UE 215 among others. In some instances, the indication of the request may be included in the message at a QoS flow level, at a PDU session level, or at the DRB level. Upon receiving the PDU information set marking request, the master CU-CP 262-a may send the request to the core network 230, such as described with reference to 325-a.

At step 325-c, in some cases, the RAN node 205 may signal the request, or an indication of the request, via a message transmitted via the F1 interface. In such cases, the PDU set information marking request may be included in a PDU set information marking request IE that is transmitted by the DU 265 to the CU-CP 262 via the F1 interface. For instance, referring back to FIG. 7, in some examples, the indication of the request (e.g., the PDU set information marking request IE) may be included in a UE-specific message (e.g., such as a message specific to the UE 215), such as a UE context setup response message 710-a of F1 interface signal flow 700-a, in a UE context modification response message 710-b of F1 interface signal flow 700-b, in a UE context modification required message 705-c of F1 interface signal flow 700-c, in a notify message 705-d of F1 interface signal flow 700-d, or a combination thereof. In some cases, the indication of the request may be included in a common message, such as a gNB-DU status indication message 705-e of F1 interface signal flow 700-e. In some cases, the gNB-DU status indication message 705-e may include one or more UE identifiers associated with the PDU set information marking request. For instance, the gNB-DU status indication message 705-e may include a UE identifier associated with the UE 215 among others. In some instances, the indication of the request may be included in the message at a QoS flow level or at a DRB level. Upon receiving the PDU information set marking request, the CU-CP 262 may send the request to the core network 230, such as described with reference to 325-a.

In some cases, rather than making the request for the PDU set information marking via control plane signaling, the RAN node may make the request via user plane signaling.

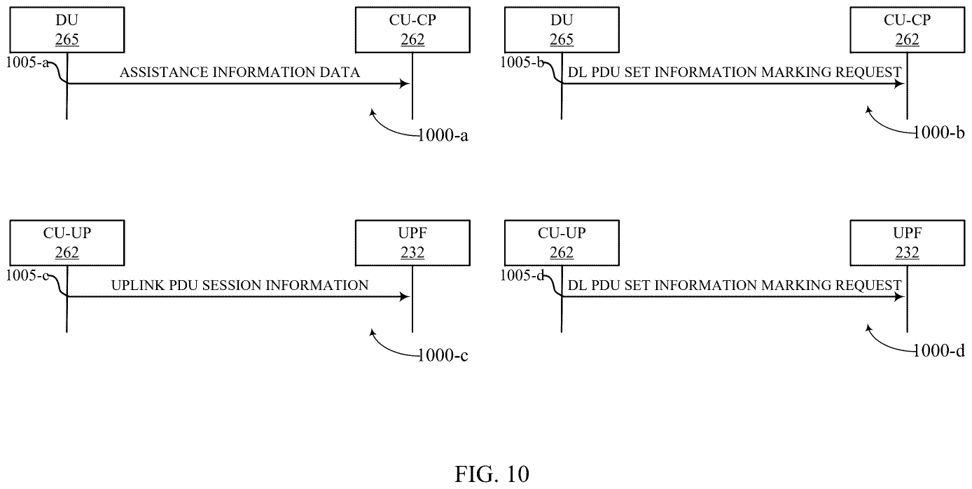

For example, at 325-d, in some cases, the RAN node 205 may signal the request, or an indication of the request, via a message transmitted via an NR interface. In such cases, the PDU set information marking request may be included in a PDU set information marking request IE that is transmitted by the DU 265 to the CU-UP 264 via the NR interface. For instance, referring to FIG. 10, in some examples, the indication of the request (e.g., the PDU set information marking request IE) may be included in a NR user plane protocol message, such as an assistance information data message 1005-a of signal flow 1000-a. In some cases, such as when the UE 215 may be configured to operate in dual connectivity a node of the RAN node 205 may signal the request for PDU set information marking to a node hosing PDCP during the dual connectivity operation, through the assistance information data message. In other examples, the indication of the request may be included a PDU set information user plane protocol, such as a downlink PDU set information marking request message 1005-b of the signal flow 1000-b. In this case, the PDU set information marking request message 1005-b may carry a marking request indicator IE and a marking request IE. The marking request indicator IE may indicate whether a marking request is present in the message. For instance, a value of the marking request indicator may be 0 if the marking request is not present in the message, or may be 1 if the marking request is present in the message. The marking request IE, when present, may be 0 when the request is for deactivation of PDU set information marking and may be 1 when the request is for activation of PDU set information marking.

At 325-e, after receiving the indication of the request for PDU set information marking, the CU-UP 264 may signal the request to the core network 230.

For instance, the CU-UP 264 may transmit, and the UPF 232 of the core network 230 may receive, a message including the indication of the request for the PDU set information marking. For instance, in some examples, the indication of the request (e.g., the PDU set information marking request IE) may be included in a PDU session user plane protocol frame, such as an uplink PDU session information frame 1005-c of signal flow 1000-c. In other examples, the indication of the request (e.g., the marking request indicator IE and the marking request IE) may be included in a PDU set information user plane protocol message, such as a downlink PDU set information marking request 1005-d of signal flow 1000-d.

At 330, after receiving the indication of the request for PDU set information marking, the core network 230 may perform the PDU set information marking on the data traffic flow requested by the UE 215. In some cases, performing the PDU set information marking may cause the PDU set information marking to be deactivated from the data traffic flow requested by the UE 215. In other cases, performing the PDU set information marking may cause the PDU set information marking to be activated for the data traffic flow requested by the UE 215. Activating the PDU set information marking may cause one or more PDUs of one or more PDU sets 235 transmitted in the data traffic flow to be marked with PDU set information. For instance, the UPF 232 of the core network 230 (e.g., a PSA UPF) may identify PDU set information associated with one or more of the PDU sets 235 and include the PDU set information in a GTP-U header of one or more of the PDUs in the PDU sets 235. The PDU set information may relate to characteristics of a corresponding PDU set 235. For instance, the PDU set information may include a sequence number of the PDU set 235, sequence numbers of PDUs within the PDU set 235, an indication of an end PDU of the PDU set 235, a size of the PDU set 235, an indication of an importance or the PDU set 235, or the like.

At 335, the core network 230 may transmit, and the RAN node 205 (e.g., to the DU 265 of the RAN node 205) may receive, the data traffic flow with one or more of the PDUs of the PDU sets 235 marked with PDU set information.

At 340, the RAN node 205 may determine to discard one or more of the PDU sets 235 based on the PDU set information marking. For instance, in the case of congestion (e.g., when a threshold level of congestion is detected), the RAN node 205 may determine utilize the PDU set importance indication included in the PDU set information to determine (e.g., when the PDU set importance indication satisfies a threshold) whether to discard one or more of the PDU sets 235.

At 345, the RAN node 205 may forward the data traffic flow to the UE 215. In some cases, the data traffic flow may exclude one or more PDUs that were discarded by the RAN node 205 based on the PDU set information marking.

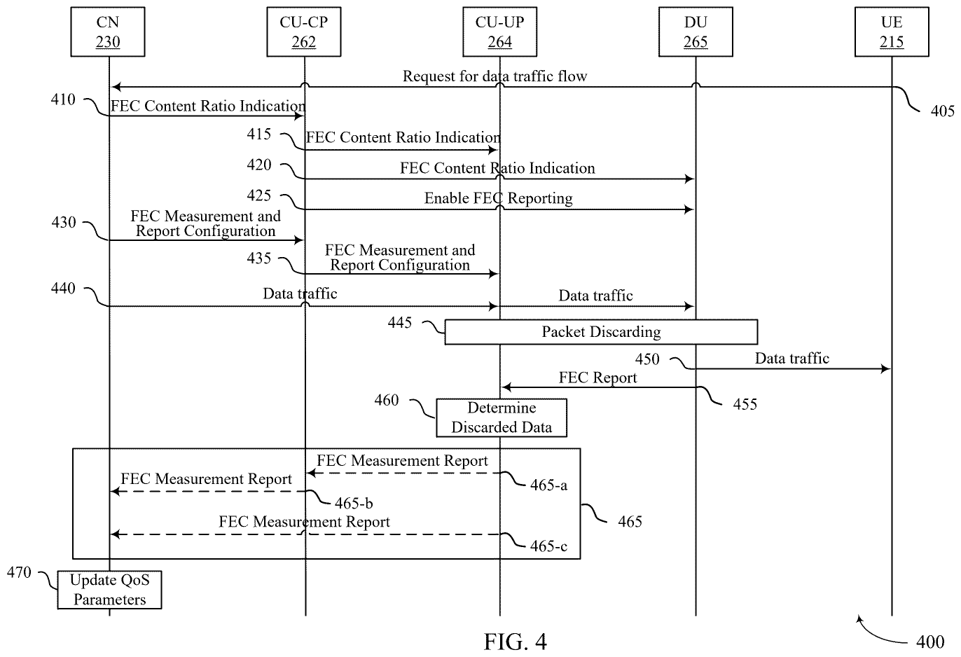

FIG. 4 shows an example of a signal flow 400 that supports techniques for RAN signaling for FEC awareness in accordance with one or more aspects of the present disclosure. In some examples, signal flow 400 may implement aspects of or may be implemented by aspects of wireless communications systems 100-a and 200 and network architecture 100-b, described with reference to FIGS. 1A, 1B, and 2. Signal flow 400 may be implemented by the core network 230 (including one or more of the UPF 232, AMF 234, and SMF 236 of the core network 230), the RAN node 205 (and one or more of the CU-CP 262, the CU-UP 264, and the DU 265 of the RAN node 205), and the UE 215, described with reference to FIG. 2. In the following description of the signal flow 400, the communications between the various entities or nodes may be performed in different orders or at different times. Some operations may also be omitted from the signal flow 400, and other operations may be added to the signal flow 400. In some examples, the operations illustrated in signal flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added. In some cases, one or more of the signals described with respect to FIG. 4 may communicate information (e.g., an indication, a request, measurements, etc.) that may be included in one or more messages that may be transmitted between entities (e.g., nodes) via one or more interfaces, as described in further detail with respect to FIGS. 5 to 10.

At 405, the UE 215 may transmit (e.g., via the core network 230, the RAN node 205, or both), and the core network 230 may receive, a request for a data traffic flow associated with a service provided by an application server (such as the application server 220 of FIG. 2). For instance, the UE 215 may request a data traffic flow associated with an XR service. In some cases, the core network 230 will request and receive the data traffic flow from the application server 220. In some implementations, the application server 220 may apply FEC and, as a result, may include, in a set of IP packets 225 associated with the data traffic flow, one or more additional repair packets. The repair packets, together with the original packets associated with the data (e.g., packets associated with a video frame), may enable the UE 215, when the UE 215 receives the packets, to reconstruct the data (e.g., reconstruct the video frame) corresponding to the set of IP packets 225 using a subset of the IP packets 225. Accordingly, the UPF 232 of the core network 230 may bundle IP packets associated with the requested data traffic flow, and received from the application server 220, into groups of PDUs to create one or more PDU sets 235. Based on FEC being applied by the application server 220, one or more of the PDU sets 235 may include a number (e.g., quantity) of source symbols that correspond to the original packets and also a number (e.g., quantity) of repair symbols that correspond to additional packets that enable the UE 215 to reconstruct the data using a subset of the PDUs in the PDU set 235. Each of the PDU sets 235 may satisfy a FEC content ratio of additional repair packets to a total quantity of packets (e.g., N) in the PDU set 235. For instance, 30-50% of the total quantity of packets in a PDU set 235 may be the additional repair packets. Accordingly, the core network 230 may configure one or more QoS flows 250 associated with the data traffic flow with FEC awareness.

At 410, the core network 230 may send, and the CU-CP 262 may receive, an indication of a FEC content ratio associated with the requested data traffic flow. For example, the core network 230 may signal the FEC content ratio when a PDU session is set up or modified. In this case, the indication of the FEC content ratio may be included in a message (e.g., in a FEC content ratio IE) that is transmitted via an NG interface. For instance, referring to FIG. 5, the FEC content ratio may be included in a NG-AP message, such as a PDU session resource setup request message 505-a of NG interface signal flow 500-a, in a PDU session resource modify request message 505-b of NG interface signal flow 500-b, or in a combination thereof. In some instances, the indication may be included in the message at a QoS flow level.

At 415, the CU-CP 262 may forward the FEC content ratio indication to the CU-UP 264. For instance, the CU-CP 262 may send (e.g., transmit), and the CU-UP 264 may receive, an indication of the FEC content ratio. For example, the CU-CP 262 may signal the indication when a bearer is setup or modified. In this case, the indication of the FEC content ratio may be included in a message (e.g., in a FEC content ratio IE) that is transmitted via an E1 interface. For instance, referring to FIG. 6, the indication of the FEC content ratio may be included in an E1-AP message, such as a bearer context setup request message 605-a of E1 interface signal flow 600-a, a bearer context modification request message 605-b of E1 interface signal flow 600-b, or a combination thereof. In some instances, the indication may be included in the message at a QoS flow level.

At 420, the CU-CP 262 may forward the indication of the FEC content ratio to the DU 265. For instance, the CU-CP 262 may send (e.g., transmit), and the DU 265 may receive, an indication of FEC content ratio. For example, the CU-CP 262 may signal the indication of the FEC content ratio when a UE context is setup or modified. In this case, the indication of the FEC content ratio may be included in a message (e.g., in a FEC content ratio IE) that is transmitted via an F1 interface. For instance, referring to FIG. 7, the indication may be included in an FI-AP message, such as a UE context setup request message 705-a of F1 interface signal flow 700-a, a UE context modification request message 705-b of F1 interface signal flow 700-b, or a combination thereof. In some instances, the indication may be included in the message at a QoS flow level.

In some examples, the CU-CP 262 of the RAN node 205 may forward the indication of the FEC content ratio to a CU-CP associated with another RAN node. For instance, during an Xn handover or during an RRC re-establishment procedure (e.g., during a retrieve UE context procedure), the CU-CP 262 of the RAN node 205 may be a source CU-CP 262-a (or an old CU-CP 262-a) of a source (or old) RAN node 205-a, and the source CU-CP 262-a (or old CU-CP 262-a) may signal the capability indication to a target CU-CP 262-b (or new CU-CP 262-b) of a target (or new) RAN node 205-b. Accordingly, the source CU-CP 262-a (or old CU-CP 262-a) may transmit, and the target CU-CP 262-b (or new CU-CP 262-b) may receive, the indication of FEC content ratio. In this case, the indication of the FEC content ratio may be included in a message (e.g., in a FEC content ratio IE) that is transmitted via an Xn interface. For instance, referring to FIG. 9, the indication may be included in a handover request message 905-a of Xn interface signal flow 900-a, a retrieve UE context response message 905-b of Xn interface signal flow 900-b, or a combination thereof. In some instances, the indication may be included in the message at a QoS flow level.

At 425, the CU-CP 262 may control an activation of FEC reporting at the DU 265. For instance, the CU-CP 262 may configure the DU 265 to enable the DU 265 to send one or more FEC reports indicating information associated with one or more PDUs discarded by the DU 265 based on the FEC content ratio. For example, the CU-CP 262 may signal activation of FEC reporting when a UE context is setup or modified. In this case, an indication of activation of FEC reporting may be included in a message (e.g., in a FEC report enabled IE) that is transmitted via an F1 interface. For instance, referring to FIG. 7, the activation indication may be included in an FI-AP message, such as a UE context setup request message 705-a of F1 interface signal flow 700-a, a UE context modification request message 705-b of F1 interface signal flow 700-b, or a combination thereof.

At 430, the core network 230 may configure the CU-CP 262 to perform FEC measurement and reporting. For example, for each UE 215 with one or more QoS flows configured with FEC awareness, the core network 230 (e.g., SMF 236 of the core network 230) may provide the CU-UP 264 with an FEC measurement and reporting configuration. The FEC measurement and reporting configuration may indicate for a given QoS flow (e.g., based on a QoS flow identifier) a type of reporting, such as periodic or event-triggered. In the case that the reporting is periodic, the configuration may additionally include the period for reporting. In the case that the reporting is event-triggered, the configuration may additionally include an indication of an event that triggers the reporting. For example, the report may be triggered based on detecting that an associated measurement is different from a previous measurement by a threshold amount. In some cases, the threshold value may be provided by the core network 230 via the configuration. The configuration, in some cases, may indicate QoS flows (e.g., based on QoS flow identifiers) to be added (e.g., to enable reporting), modified, or removed (e.g., to disable reporting) from the list of configured QoS flows.

The core network 230 may signal the FEC measurement and reporting configuration in a NG-AP message (e.g., in a FEC measurement and reporting configuration IE). For instance, referring to FIG. 5, the indication of the FEC measurement and reporting configuration may be included in an NG-AP message, such as a PDU session resource setup request message 505-a of NG interface signal flow 500-a, a PDU session resource modify request message 505-b of NG interface signal flow 500-b, a measurement configuration request message, or a combination thereof.

At 435, the CU-CP 262 may configure the CU-UP 264 to perform FEC measurement and reporting. For example, for each UE 215 with one or more QoS flows configured with FEC awareness, the CU-CP 262 may provide the CU-UP 264 with a new FEC measurement and reporting configuration. The FEC measurement and reporting configuration may indicate for a given QoS flow (e.g., based on a QoS flow identifier) a type of reporting, such as periodic or event-triggered. In the case that the reporting is periodic, the configuration may additionally include the period for reporting. In the case that the reporting is event-triggered, the configuration may additionally include an indication of an event that triggers the reporting. For example, the report may be triggered based on detecting that an associated measurement is different from a previous measurement by a threshold amount. In some cases, the threshold value may be provided by the CU-CP 262 via the configuration. The configuration, in some cases, may indicate QoS flows (e.g., based on QoS flow identifiers) to be added (e.g., to enable reporting), modified, or removed (e.g., to disable reporting) from the list of configured QoS flows.

The CU-CP 262 may signal FEC measurement and reporting configuration to the CU-UP 264 when a bearer context is setup or modified. In this case, an indication of FEC measurement and reporting configuration may be included in a message (e.g., in a FEC measurement and reporting configuration IE) that is transmitted via an E1 interface. For instance, referring to FIG. 6, the indication of the FEC measurement and reporting configuration may be included in an E1-AP message, such as a bearer context setup request message 605-a of E1 interface signal flow 600-a, a bearer context modification request message 605-b of E1 interface signal flow 600-b, or a combination thereof.

At 440, the core network 230 may send, and the RAN node 205 (e.g., the CU-UP 264) may receive, the data traffic flow requested by the UE 215. The CU-UP 264 may additional data traffic (e.g., the PDCP PDUs) to the DU 265. For instance, the data traffic may be received at one or more buffers of the RAN node 205.

At 445, CU-UP 264, the DU 265, or both may may discard one or more PDUs based on the indicated FEC content ratio. For instance, at 450, the DU 265 may concurrently schedule transmission of the PDUs from the one or more buffers (e.g., one or more buffers associated with the CU-UP 264 or the DU 265) to the UE 215, and the DU 265 may determine whether an amount of PDUs transmitted successfully to the UE 215 satisfies the FEC content ratio. For instance, if the DU 265 (or the CU-UP 264) determines that the UE 215 has successfully received at least the quantity of original packets associated with the data (e.g., based on the FEC content ratio), the DU 265 (or the CU-UP 264) may determine that the UE 215 has received a sufficient quantity of the PDUs. Based on the quantity of PDUs successfully received at the UE 215 satisfying the FEC content ratio, the CU-UP 264, the DU 265, or both may discard any remaining (e.g., obsolete) PDUs not yet transmitted to the UE 215 (e.g., PDUs remaining in the one or more buffers associated with the RAN node 205). For instance, the obsolete PDUs may be RLC PDUs remaining in an RLC transmission buffer, RLC PDUs remaining in a RLC retransmission buffer, segments of RLC PDUs in the RLC retransmission buffer, MAC PDUs in an HARQ retransmission buffer, or the link.

At 455, the DU 265 may send, and the CU-UP 264 may receive, a FEC report indicating information associated with the discarded PDUs. For instance, the DU 265 may report, to the CU-UP 264, any PDUs that the DU 265 discards. The FEC report may include information associated with the discarded PDUs, such as a PDU set sequence number, a quantity of discarded PDUs, a sequence number of each of the discarded PDUs. For instance, it may be helpful for the CU-UP 264 to be informed of the specific PDUs discarded by the DU 265, so that when the CU-UP 264 performs its own count of discarded PDUs, the CU-UP 264 does not double count those that were discarded by both the DU 265 and the CU-UP 264. In some cases, the FEC report may be included in NR user plane frame, such as a downlink data delivery status frame or a downlink data FEC status frame.

At 460, after receiving one or more FEC reports from the DU 265, the CU-UP 264 may determine measurement information associated with the PDUs discarded by both the DU 265 and the CU-UP 264. For instance, the CU-UP 264 may determine a total quantity of PDUs discarded between the DU 265 and the CU-UP 264 (e.g., for a given QoS flow). In this case, the CU-UP 264 may, for each PDU set 235 (e.g., associated with the QoS flow), count the quantity of PDUs from the FEC reports sent to the CU-UP 264 from the DU 265, and the quantity of PDUs (and service data units (SDU)s) remaining in one or more buffers associated with the CU-UP 264. The CU-UP 264 may sum the two quantities to determine a total quantity of PDUs discarded based on the FEC content ratio being satisfied. In some cases, the CU-UP 264 may additionally determine a suggested FEC content ratio for the QoS flow 250 (e.g., such as an updated FEC content ratio). The CU-UP 264 may generate a FEC measurement report, which may include, at least, the total quantity of discarded PDUs for the QoS flow 250 and the suggested FEC content ratio. The FEC measurement report may additionally include an identifier associated with the QoS flow, a ratio of discarded PDUs to a total quantity of PDUs since a last FEC measurement report, and PDU set information associated with each PDU set 235 associated with QoS flow 250. The PDU set information may include, for each PDU set 235, a PDU set number and a ratio of discarded PDUs to a quantity of PDUs in the PDU set 235.

At 465, CU-UP 264 may send, and the core network 230 may receive, the FEC measurement report. The CU-UP 264 may optionally send the FEC measurement report via control plane signaling (such as by reporting the FEC measurement report to the CU-CP 262, which reports the FEC measurement report to the SMF 236 of the core network 230, which in turn reports the FEC measurement report to the UPF 232 of the core network 230) or via user plane signaling (such as by reporting the FEC measurement report directly to the UPF 232).

For example, at 465-a, when the CU-UP 264 sends the FEC measurement report via control plane signaling, the CU-UP 264 may send, and the CU-CP 262 may receive, an indication of the FEC measurement report (e.g., in a FEC measurement report IE). In this case, the indication of the FEC measurement report (e.g., the FEC measurement report IE) may be included in a message that is transmitted via an E1 interface. For instance, referring to FIG. 6, the indication of the FEC measurement report may be included in an E1-AP message, such as a data usage report message 605-f of E1 interface signal flow 600-f, a downlink data notification message 605-g of E1 interface signal flow 600-g, a UE measurement report message 605-h of E1 interface signal flow 600-h, or a combination thereof. In some instances, the indication may be included in the message at a QoS flow level.

At 465-b, the CU-CP 262 may report the FEC measurement report received from the CU-UP 264 to the core network 230 (e.g., to the SMF 236 of the core network 230). For instance, the CU-CP 262 may send, and the core network 230 (e.g., to the SMF 236) may receive, the FEC measurement report. In this case, the indication of the FEC measurement report (e.g., the FEC measurement report IE) may be included in an NG-AP message, such as a measurement report message. In some cases, the SMF 236 may send the FEC measurement report to the UPF 232 of the core network 230.

At 465-c, when the CU-UP 264 sends the FEC measurement report via user plane signaling, the CU-UP 264 may send the FEC measurement report directly to the core network 230 (e.g., to the UPF 232 of the core network 230). For instance, the CU-UP 264 may send, and the core network 230 may receive, an indication of the FEC measurement report. In this case, the indication of the FEC measurement report may be included in an uplink PDU session information frame (e.g., in a FEC report information IE) of the PDU session user plane protocol. For instance, referring to FIG. 10, the indication of the FEC measurement report may be included in a PDU session user plane protocol frame, such as an uplink PDU session information frame 1005-c of signal flow 1000-c. In some cases, the uplink PDU session information frame may additionally include a flag that indicates whether the FEC report information is present.

At 470, based on receiving the FEC measurement report, the core network 230 may update one or more QoS monitoring parameters. For instance, the core network 230 may update one or more of the QoS monitoring parameters based on information included in the FEC measurement report. In some cases, to enable information associated with the discarded PDUs to be reported to the AF 239 of the core network 230 from the SMF 236, the AMF 234, or the UPF 232, the core network 230 may add the FEC measurement report to an EventNotification structure of an Nsmf_EventExposure Service API, QoSMonitoringReport structure of an Npcf_SMPolicyControl Service API, QoSMonitoringReport structure of an Npcf_PolicyAuthorization Service API, QoSMonitoringMeasurement structure of the Nupf_EventExposure Service API, or a combination thereof.

In some cases, the AF 239 may request information (e.g., measurements) associated with discarded PDU from one or more of the QoS monitoring parameters. The request may trigger QoS monitoring control for one or more service data flows 240. The request for the information associated with the discarded PDUs may be added to a QoSMonitoringData structure and to a QosMonitoringParamType enumerate of the Npcf_SMPolicyControl Service API. In response to the request, a QoS monitoring report may be sent to the AF 239. In some implementations, the PCF 238 may determine whether a QoS monitoring report is sent to the AF 239 by the SMF 236, bypassing the PCF 238, or if the QoS monitoring report is sent to the AF 239 by the SMF 236 via the PCF 238. In some cases, the QoS monitoring report may be sent directly from the UPF 232 to the AF 239.

FIG. 5 shows examples of E1 interface signal flows 500 (e.g., NG interface signal flows 500-a, 500-b, 500-c, 500-d, 500-e, and 500-f) that support RAN signaling PDU set information marking in accordance with one or more aspects of the present disclosure. The NG interface signal flows 500 (e.g., NG interface signal flows 500-a, 500-b, 500-c, 500-d, 500-e, and 500-f) may show one or more messages communicated between the CU-CP 262 of the RAN node 205 and the AMF 234 of the core network 230, described with reference to FIG. 2, using an NG interface.

FIG. 6 shows examples of E1 interface signal flows 600 (e.g., E1 interface signal flows 600-a, 600-b, 600-c, 600-d, 600-e, 600-f, 600-g, and 600-h) that support RAN signaling PDU set information marking in accordance with one or more aspects of the present disclosure. The E1 interface signal flows 600 (e.g., E1 interface signal flows 600-a, 600-b, 600-c, 600-d, 600-e, 600-f, 600-g, and 600-h) may show one or more messages communicated between the CU-CP 262 of the RAN node 205 and the CU-UP 264 of the RAN node 205.

FIG. 7 shows examples of F1 interface signal flows 700 (e.g., F1 interface signal flows 700-a, 700-b, 700-c, 700-d, and 700-e) that support RAN signaling PDU set information marking in accordance with one or more aspects of the present disclosure. The F1 interface signal flows 700 (e.g., F1 interface signal flows 700-a, 700-b, 700-c, 700-d, and 700-e) may show one or more messages communicated between the CU-CP 262 of the RAN node 205 and the DU 265 of the RAN node 205.

FIGS. 8 and 9 show examples of Xn interface signal flows 800 (e.g., Xn interface signal flows 800-a, 800-b, 800-c, 800-d, 800-e, and 800-f) and 900 (e.g., Xn interface signal flows 900-a and 900-b) that support RAN signaling for PDU set information marking in accordance with one or more aspects of the present disclosure. The Xn interface signal flows 800 (e.g., Xn interface signal flows 800-a, 800-b, 800-c, 800-d, 800-e, and 800-f) may show one or more messages communicated between a master CU-CP 262-a of a master RAN node 205 and a secondary CU-CP 262-b of secondary RAN node 205. The Xn interface signal flows 900 (e.g., Xn interface signal flows 900-a and 900-b) may show one or more messages communicated between a source/old CU-CP 262-a of a source/old RAN node 205 and a target/new CU-CP 262-b of a target/new RAN node 205.

FIG. 10 shows examples of signal flows 1000 (e.g., signal flows 1000-a, 1000-b, 1000-c, and 1000-d) that support RAN signaling for PDU set information marking in accordance with one or more aspects of the present disclosure. The signal flows 1000 (e.g., signal flows 1000-a, 1000-b, 1000-c, and 1000-d) may show one or more messages communicated between the DU 265 of the RAN node 205, a CU-CP 262 of the RAN node 205, a CU-UP 264 of the RAN node 205, and the UPF 232 of the core network 230, described with reference to FIG. 2, using an NR interface.

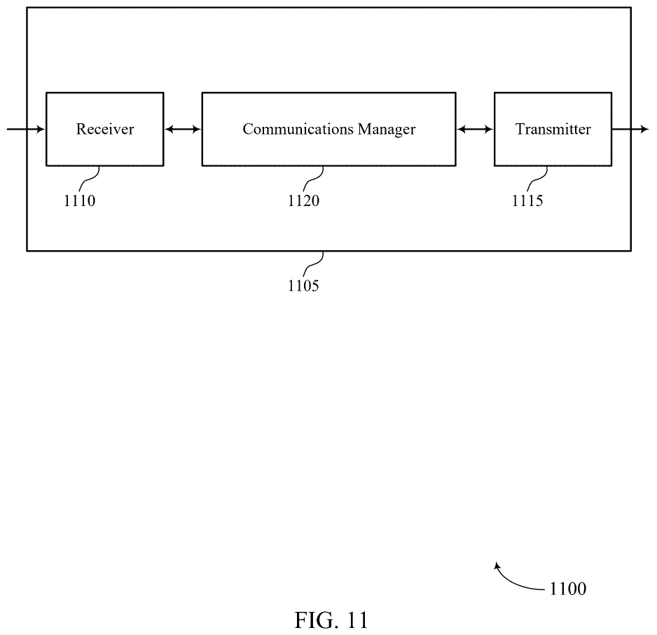

FIG. 11 shows a block diagram 1100 of a device 1105 that supports techniques for RAN signaling for FEC awareness and PDU set information marking in accordance with one or more aspects of the present disclosure. The device 1105 may be an example of aspects of a RAN node as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for RAN signaling for FEC awareness and PDU set information marking as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving, from a second node, a first indication of a forward error correction (FEC) content ratio for a data traffic flow, where the data traffic flow includes one or more packet data unit (PDU) sets associated with a QoS flow. The communications manager 1120 is capable of, configured to, or operable to support a means for transmitting, based on the FEC content ratio, an FEC report that indicates a number of discarded PDUs of the one or more PDU sets, where the discarded PDUs are discarded from a buffer of a DU associated with the first RAN node.

Additionally, or alternatively, the communications manager 1120 may support wireless communications in accordance with examples as disclosed herein. For example, the communications manager 1120 is capable of, configured to, or operable to support a means for receiving, from a second node and via an interface, a first indication of a capability of a core network to support packet data unit (PDU) set information marking. The communications manager 1120 is capable of, configured to, or operable to support a means for transmitting, to the second node and via the interface, based on the capability of the core network, a PDU set information marking request associated with a data traffic flow between the second node and a UE, where the data traffic flow includes one or more PDU sets associated with a QoS flow. The communications manager 1120 is capable of, configured to, or operable to support a means for receiving the data traffic with PDU set information marking, responsive to the PDU set information marking request and independent of whether a PDU set QoS configuration is associated with the QoS flow.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for power consumption and more efficient utilization of communication resources.

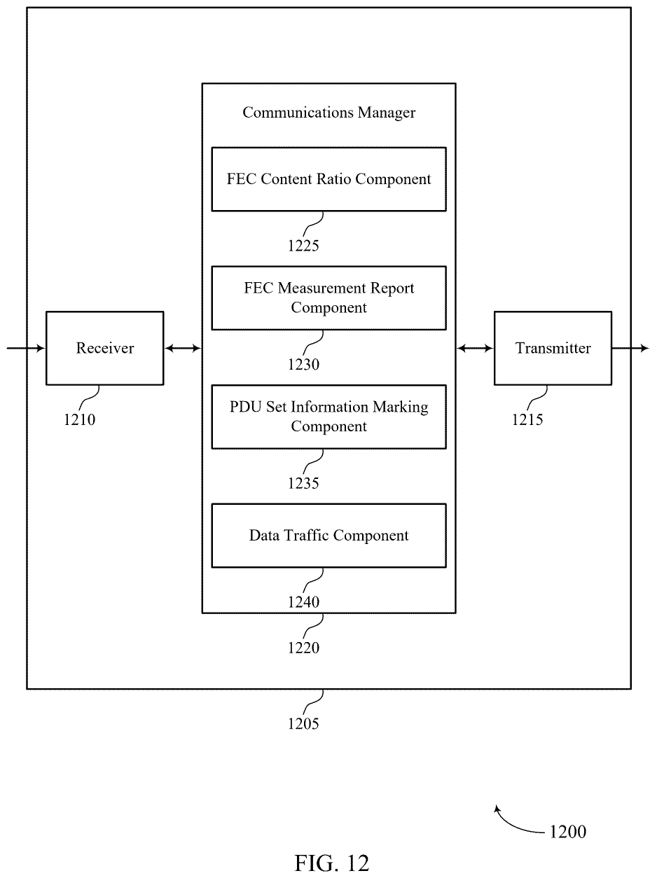

FIG. 12 shows a block diagram 1200 of a device 1205 that supports techniques for RAN signaling for FEC awareness and PDU set information marking in accordance with one or more aspects of the present disclosure. The device 1205 may be an example of aspects of a device 1105 or a RAN node 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for RAN signaling for FEC awareness and PDU set information marking as described herein. For example, the communications manager 1220 may include a FEC Content Ratio Component 1225, a FEC Measurement Report Component 1230, a PDU set information marking component 1235, a data traffic component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The FEC Content Ratio Component 1225 is capable of, configured to, or operable to support a means for receiving, from a second node, a first indication of a forward error correction (FEC) content ratio for a data traffic flow, where the data traffic flow includes one or more packet data unit (PDU) sets associated with a QoS flow. The FEC Measurement Report Component 1230 is capable of, configured to, or operable to support a means for transmitting, based on the FEC content ratio, an FEC report that indicates a number of discarded PDUs of the one or more PDU sets, where the discarded PDUs are discarded from a buffer of a DU associated with the first RAN node.

Additionally, or alternatively, the communications manager 1220 may support wireless communications in accordance with examples as disclosed herein. The PDU set information marking component 1235 is capable of, configured to, or operable to support a means for receiving, from a second node and via an interface, a first indication of a capability of a core network to support packet data unit (PDU) set information marking. The PDU set information marking component 1235 is capable of, configured to, or operable to support a means for transmitting, to the second node and via the interface, based on the capability of the core network, a PDU set information marking request associated with a data traffic flow between the second node and a UE, where the data traffic flow includes one or more PDU sets associated with a QoS flow. The data traffic component 1240 is capable of, configured to, or operable to support a means for receiving the data traffic with PDU set information marking, responsive to the PDU set information marking request and independent of whether a PDU set QoS configuration is associated with the QoS flow.

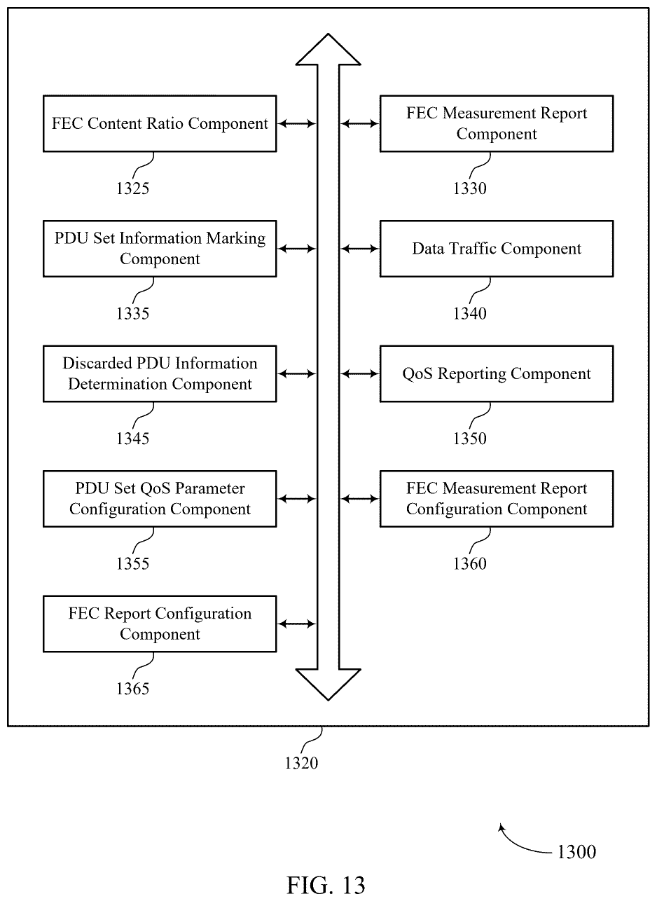

FIG. 13 shows a block diagram 1300 of a communications manager 1320 that supports techniques for RAN signaling for FEC awareness and PDU set information marking in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for RAN signaling for FEC awareness and PDU set information marking as described herein. For example, the communications manager 1320 may include a FEC Content Ratio Component 1325, a FEC Measurement Report Component 1330, a PDU set information marking component 1335, a data traffic component 1340, a discarded PDU information determination component 1345, a QoS reporting component 1350, a PDU set QoS parameter configuration component 1355, a FEC measurement report configuration component 1360, a FEC report configuration component 1365, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The FEC Content Ratio Component 1325 is capable of, configured to, or operable to support a means for receiving, from a second node, a first indication of a forward error correction (FEC) content ratio for a data traffic flow, where the data traffic flow includes one or more packet data unit (PDU) sets associated with a QoS flow. The FEC Measurement Report Component 1330 is capable of, configured to, or operable to support a means for transmitting, based on the FEC content ratio, an FEC report that indicates a number of discarded PDUs of the one or more PDU sets, where the discarded PDUs are discarded from a buffer of a DU associated with the first RAN node.

In some examples, the first indication is included in an IE of a first message.

In some examples, the first indication is included in a first message at a QoS flow level.

In some examples, the first RAN node includes a CU-CP. In some examples, the second node includes a SMF of a core network.

In some examples, the first indication is included in a PDU session resource setup request message or a PDU session resource modify request message.

In some examples, the FEC Content Ratio Component 1325 is capable of, configured to, or operable to support a means for transmitting a second indication of the FEC content ratio to a CU-UP associated with the first RAN node via an E1 interface, where the second indication is included in a bearer context setup request message or a bearer context modification request message.

In some examples, the FEC Content Ratio Component 1325 is capable of, configured to, or operable to support a means for transmitting a second indication of the FEC content ratio to the DU via an F1 interface, where the second indication is included in a UE context setup request message or a UE context modification request message.

In some examples, the first RAN node is a source CU-CP, and the FEC Content Ratio Component 1325 is capable of, configured to, or operable to support a means for transmitting a second indication of the FEC content ratio to a target CU-CP via an Xn interface, where the second indication is included in a handover request message or a retrieve UE context response message.

In some examples, the FEC Measurement Report Component 1330 is capable of, configured to, or operable to support a means for receiving, from a CU-UP associated with the first RAN node, a second indication of the discarded PDUs of the one or more PDU sets, where the second indication is per PDU set.

In some examples, the discarded PDUs include one or more of RLC PDUs discarded from an RLC transmission buffer of the DU, RLC PDUs discarded from an RLC retransmission buffer of the DU, segments of RLC PDUs discarded from the RLC retransmission buffer of the DU, medium access control (MAC) PDUs discarded from an HARQ retransmission buffer of the DU, or a combination thereof.

In some examples, the second indication includes a PDU set sequence number associated with a PDU set of the one or more PDU sets, a number of discarded PDUs from the PDU set, a PDU sequence number associated with each of the discarded PDUs from the PDU set, or combinations thereof.

In some examples, the second indication is received over a New Radio (NR) interface via a downlink data delivery status message or a downlink data FEC status message.

In some examples, the FEC report configuration component 1365 is capable of, configured to, or operable to support a means for transmitting, to the DU, a third indication of activation of FEC reporting, where the second indication of the discarded PDUs is received based on the third indication.

In some examples, the third indication is transmitted to the DU via an F1 interface and is included in a UE context setup request message or a UE context modification request message.

In some examples, the FEC measurement report configuration component 1360 is capable of, configured to, or operable to support a means for transmitting, to a CU-UP associated with the first RAN node, a second indication of an FEC measurement and reporting configuration associated with a UE associated with the QoS flow.

In some examples, the second indication is transmitted via an F1 interface and is included in a bearer context setup request message or a bearer context modification request message.

In some examples, the FEC Content Ratio Component 1325 is capable of, configured to, or operable to support a means for receiving, from the CU-UP, a third indication of a suggested FEC content ratio for inclusion in the FEC report.

In some examples, the FEC measurement report configuration component 1360 is capable of, configured to, or operable to support a means for receiving, from the CU-UP, a third indication of an FEC measurement report in accordance with the FEC measurement and reporting configuration, where the FEC measurement report includes one or more of a QoS flow identifier associated with the QoS flow, a total number of PDUs since a last FEC measurement report, a ratio of discarded PDUs to a total number of PDUs since a last FEC measurement report, a suggested FEC content ratio, or discarded PDU set information, and where the discarded PDU set information includes, for each PDU set included in the discarded PDU set information, a PDU set sequence number associated with the PDU set and a ratio of discarded PDUs from the PDU set to a total number of PDUs in the PDU set, where the discarded PDU set information is based on discarded PDUs at the DU and on one or more PDUs remaining in a buffer of the CU-UP.

In some examples, the third indication is received via an E1 interface and is included in a downlink data notification message, a data usage report message, or a UE measurement report message.

In some examples, the FEC measurement report configuration component 1360 is capable of, configured to, or operable to support a means for receiving, from the SMF, a second indication of an FEC measurement and reporting configuration associated with a UE associated with the QoS flow.

In some examples, the second indication is received via an NG interface and is included in a measurement configuration request message, a PDU session resource setup request message, or a PDU session resource modify request message.

In some examples, the discarded PDU information determination component 1345 is capable of, configured to, or operable to support a means for determining, for each PDU set of the one or more PDU sets and based on discarded PDUs indicated in one or more FEC reports received from the DU or on one or more PDUs remaining in a buffer of the CU-CP, discarded PDU information.

In some examples, the FEC report is transmitted to the SMF and includes one or more of a QoS flow identifier associated with the QoS flow, a total number of PDUs since a last FEC measurement report, a ratio of discarded PDUs to a total number of PDUs since a last FEC measurement report, a suggested FEC content ratio, or discarded PDU set information. In some examples, the discarded PDU set information includes, for each PDU set included in the discarded PDU information, a PDU set sequence number associated with the PDU set and a ratio of discarded PDUs from the PDU set to a total number of PDUs in the PDU set.

In some examples, the FEC report is transmitted via an NG interface. In some examples, the FEC report is included in a measurement report message.

In some examples, the first RAN node includes CU-UP, and the discarded PDU information determination component 1345 is capable of, configured to, or operable to support a means for determining, for each PDU set of the one or more PDU sets and based on discarded PDUs indicated in one or more FEC reports received from the DU or on one or more PDUs remaining in a buffer of the CU-UP, discarded PDU information.

In some examples, the FEC report is transmitted to a user plane function (UPF) of a core network, based on the discarded PDU information, and via an uplink PDU session information frame of a PDU session user plane protocol. In some examples, the FEC report includes one or more of a total number of PDUs since a last FEC measurement report, a ratio of discarded PDUs to a total number of PDUs since a last FEC measurement report, a suggested FEC content ratio, and PDU set information. In some examples, the PDU set information includes, for each PDU set included in the discarded PDU information, a PDU set sequence number associated with the PDU set and a ratio of discarded PDUs from the PDU set to a total number of PDUs in the PDU set.

In some examples, the QoS reporting component 1350 is capable of, configured to, or operable to support a means for updating one or more QoS monitoring parameters to include information associated with the discarded PDUs.

In some examples, the QoS reporting component 1350 is capable of, configured to, or operable to support a means for receiving, from an application function (AF) associated with a core network associated with the first RAN node, a request for measurements associated with at least one of the one or more QoS monitoring parameters.

Additionally, or alternatively, the communications manager 1320 may support wireless communications in accordance with examples as disclosed herein. The PDU set information marking component 1335 is capable of, configured to, or operable to support a means for receiving, from a second node and via an interface, a first indication of a capability of a core network to support packet data unit (PDU) set information marking. In some examples, the PDU set information marking component 1335 is capable of, configured to, or operable to support a means for transmitting, to the second node and via the interface, based on the capability of the core network, a PDU set information marking request associated with a data traffic flow between the second node and a UE, where the data traffic flow includes one or more PDU sets associated with a QoS flow. The data traffic component 1340 is capable of, configured to, or operable to support a means for receiving the data traffic with PDU set information marking, responsive to the PDU set information marking request and independent of whether a PDU set QoS configuration is associated with the QoS flow.

In some examples, the PDU set information marking is used by the first RAN node in determination of whether the first RAN node is to forward individual ones of the one or more PDU sets to the UE.

In some examples, the PDU set information marking request includes a PDU set information marking value that indicates activation or deactivation of PDU set information marking.

In some examples, the PDU set information marking value is included in a single bit IE of a second message.

In some examples, the interface is a NG interface. In some examples, the second node is an access and AMF of the core network.

In some examples, the first indication is included in a PDU session resource setup request message, a PDU session resource modify request message, or a path switch request acknowledge message. In some examples, the second indication is included in a PDU session resource setup response message, a PDU session resource modify response message, a PDU session resource modify indication message, a PDU session resource notify message, or a path switch request message.

In some examples, the first indication is included in a first message at a QoS flow level or at a PDU session level, and the PDU set information marking request is included in a second message at the QoS flow level or at the PDU session level.

In some examples, the interface includes an E1 interface. In some examples, the first RAN node includes a CU-UP and the second node includes a CU-CP associated with the first RAN node.

In some examples, the first indication is included in a bearer context setup request message or a bearer context modification request message. In some examples, the second indication is included a bearer context setup response message, a bearer context modification response message, or a bearer context modification required message.

In some examples, the second indication is included in a CU-UP status indication message that includes one or more UE identifiers associated with the PDU set information marking request.

In some examples, the first indication is included in a first message at a QoS flow level, at a bearer level or at a PDU session level, and the PDU set information marking request is included in a second message at the QoS flow level, at the bearer level, or at the PDU session level.

In some examples, the interface includes an F1 interface. In some examples, the first RAN node includes a DU and the second node includes a CU associated with the first RAN node.

In some examples, the first indication is included in a UE context setup request message or a UE context modification request message. In some examples, the second indication is included in a UE context setup response message, a UE context modification response message, a UE context modification required message, or a notify message.

In some examples, the first indication is included in a first message at a QoS flow level or at a data radio bearer (DRB) level, and the PDU set information marking request is included in a second message at the QoS flow level or at the DRB level.

In some examples, the second indication is included in a DU status indication message that includes one or more UE identifiers associated with the PDU set information marking request.

In some examples, the interface includes an Xn interface.

In some examples, the first RAN node is a target RAN node and the second node is a source RAN node. In some examples, the first indication is included in a handover request message.

In some examples, the second node is a future RAN node that is to replace the first RAN node in communication with the UE. In some examples, the first indication is included in a retrieve UE context response message.

In some examples, the first indication is included in a first message at a QoS flow level or at a PDU session level, and the PDU set information marking request is included in a second message at the QoS flow level or at the PDU session level.

In some examples, the first RAN node is a secondary RAN node and the second node is a master RAN node. In some examples, the UE is in dual connectivity with the master RAN node and the secondary RAN node.

In some examples, the first indication is included in a secondary node (S-Node) addition request message or an S-Node modification request message. In some examples, the second indication is included in a S-Node addition request acknowledge message, an S-Node modification request acknowledge message, and S-Node modification required message, or an activity notification message.

In some examples, the first indication is included in a first message at a QoS flow level or at a data radio bearer (DRB) level, and the PDU set information marking request is included in a second message at the QoS flow level or at the DRB level.

In some examples, the first indication is included in a resource status request message. In some examples, the second indication is included in a resource status update message that includes one or more UE identifiers associated with the PDU set information marking request.

In some examples, the first RAN node includes a DU and the second node includes a CU-UP associated with the first RAN node. In some examples, the second indication is included in a user plane protocol assistance information data message.

In some examples, the first RAN node and the second node are in dual connectivity operation with the UE. In some examples, the second node hosts packet data convergence protocol (PDCP) during the dual connectivity operation. In some examples, the second indication is included in a user plane protocol assistance information data message.

In some examples, the first RAN node includes a CU-UP and the second node includes a UPF of the core network. In some examples, the second indication is included in an uplink PDU session information message or downlink PDU set information marking request message.

In some examples, the downlink PDU set information marking request message includes a marking request indicator and a marking request. In some examples, the marking request indicator indicates whether the marking request is present.

In some examples, PDU set QoS parameters are not configured for the QoS flow.

In some examples, the PDU set QoS parameter configuration component 1355 is capable of, configured to, or operable to support a means for receiving, from the core network, a configuration of one or more PDU set QoS parameters, where the PDU set QoS parameters include a PDU set delay budget parameter, a PDU set error rate parameter, a PDU set integrated handling information indicator, or any combination thereof.

In some examples, the QoS reporting component 1350 is capable of, configured to, or operable to support a means for transmitting a QoS report for the data traffic flow on a per PDU set basis, where the QoS report includes one or more of the PDU set QoS parameters.

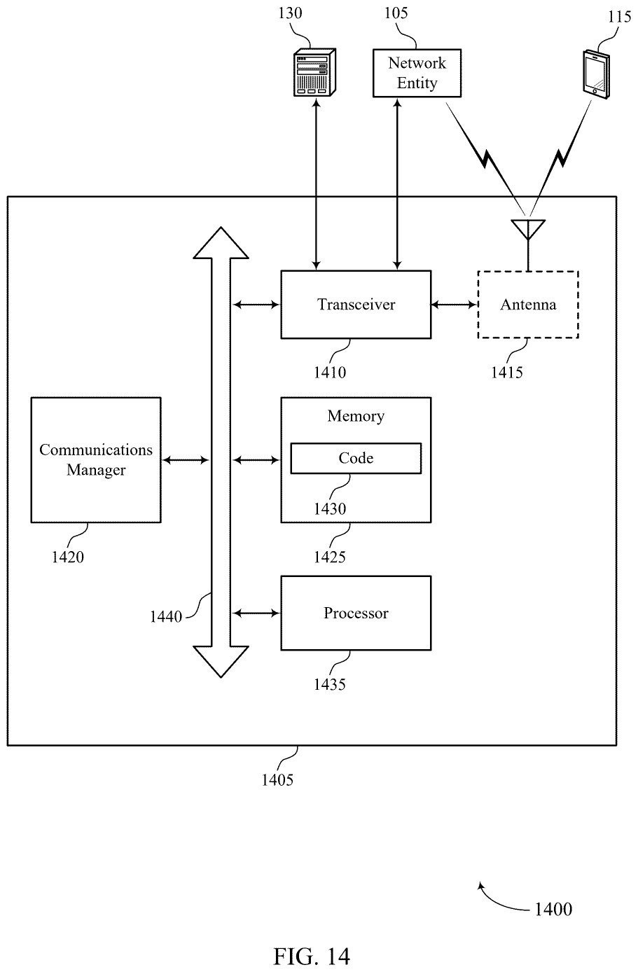

FIG. 14 shows a diagram of a system 1400 including a device 1405 that supports techniques for RAN signaling for FEC awareness and PDU set information marking in accordance with one or more aspects of the present disclosure. The device 1405 may be an example of or include components of a device 1105, a device 1205, or a RAN node as described herein. The device 1405 may include components for bi-directional voice and data communications including components for transmitting and receiving communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for RAN signaling for FEC awareness and PDU set information marking). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for receiving, from a second node, a first indication of a forward error correction (FEC) content ratio for a data traffic flow, where the data traffic flow includes one or more packet data unit (PDU) sets associated with a QoS flow. The communications manager 1420 is capable of, configured to, or operable to support a means for transmitting, based on the FEC content ratio, an FEC report that indicates a number of discarded PDUs of the one or more PDU sets, where the discarded PDUs are discarded from a buffer of a DU associated with the first RAN node.

Additionally, or alternatively, the communications manager 1420 may support wireless communications in accordance with examples as disclosed herein. For example, the communications manager 1420 is capable of, configured to, or operable to support a means for receiving, from a second node and via an interface, a first indication of a capability of a core network to support packet data unit (PDU) set information marking. The communications manager 1420 is capable of, configured to, or operable to support a means for transmitting, to the second node and via the interface, based on the capability of the core network, a PDU set information marking request associated with a data traffic flow between the second node and a UE, where the data traffic flow includes one or more PDU sets associated with a QoS flow. The communications manager 1420 is capable of, configured to, or operable to support a means for receiving the data traffic with PDU set information marking, responsive to the PDU set information marking request and independent of whether a PDU set QoS configuration is associated with the QoS flow.

By including or configuring the communications manager 1420 in accordance with examples as described herein, the device 1405 may support techniques for improved communication reliability, reduced power consumption, more efficient utilization of communication resources, and longer battery life.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for RAN signaling for FEC awareness and PDU set information marking as described herein, or the at least one processor 1435 and the at least one memory 1425 may be otherwise configured to, individually or collectively, perform or support such operations.

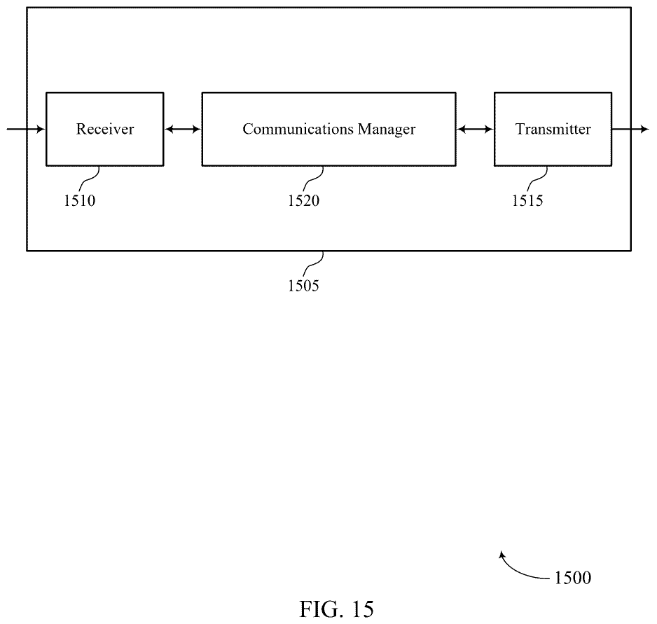

FIG. 15 shows a block diagram 1500 of a device 1505 that supports techniques for RAN signaling for FEC awareness and PDU set information marking in accordance with one or more aspects of the present disclosure. The device 1505 may be an example of aspects of a UE 115 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to techniques for RAN signaling for FEC awareness and PDU set information marking). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to techniques for RAN signaling for FEC awareness and PDU set information marking). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations or components thereof may be examples of means for performing various aspects of techniques for RAN signaling for FEC awareness and PDU set information marking as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for transmitting a request to receive a data traffic flow, where the data traffic flow includes one or more packet data unit (PDU) sets associated with a QoS flow. The communications manager 1520 is capable of, configured to, or operable to support a means for receiving at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

Additionally, or alternatively, the communications manager 1520 may support wireless communications in accordance with examples as disclosed herein. For example, the communications manager 1520 is capable of, configured to, or operable to support a means for transmitting a request to receive a data traffic flow, where the data traffic flow includes one or more packet data unit (PDU) sets associated with a QoS flow. The communications manager 1520 is capable of, configured to, or operable to support a means for receiving, via a radio access network (RAN) node and independent of whether a PDU set QoS configuration is associated with the QoS flow, at least one PDU set of the one or more PDU sets in accordance with a PDU set importance parameter included in PDU set information marking.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for reduced power consumption and more efficient utilization of communication resources.

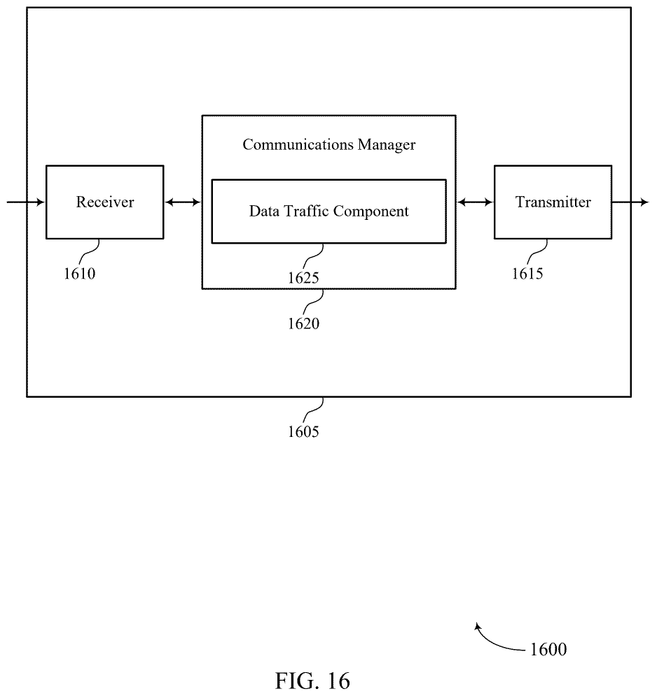

FIG. 16 shows a block diagram 1600 of a device 1605 that supports techniques for RAN signaling for FEC awareness and PDU set information marking in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605, or one of more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to techniques for RAN signaling for FEC awareness and PDU set information marking). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to techniques for RAN signaling for FEC awareness and PDU set information marking). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of techniques for RAN signaling for FEC awareness and PDU set information marking as described herein. For example, the communications manager 1620 may include a data traffic component 1625, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The data traffic component 1625 is capable of, configured to, or operable to support a means for transmitting a request to receive a data traffic flow, where the data traffic flow includes one or more packet data unit (PDU) sets associated with a QoS flow. The data traffic component 1625 is capable of, configured to, or operable to support a means for receiving at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

Additionally, or alternatively, the communications manager 1620 may support wireless communications in accordance with examples as disclosed herein. The data traffic component 1625 is capable of, configured to, or operable to support a means for transmitting a request to receive a data traffic flow, where the data traffic flow includes one or more packet data unit (PDU) sets associated with a QoS flow. The data traffic component 1625 is capable of, configured to, or operable to support a means for receiving, via a radio access network (RAN) node and independent of whether a PDU set QoS configuration is associated with the QoS flow, at least one PDU set of the one or more PDU sets in accordance with a PDU set importance parameter included in PDU set information marking.

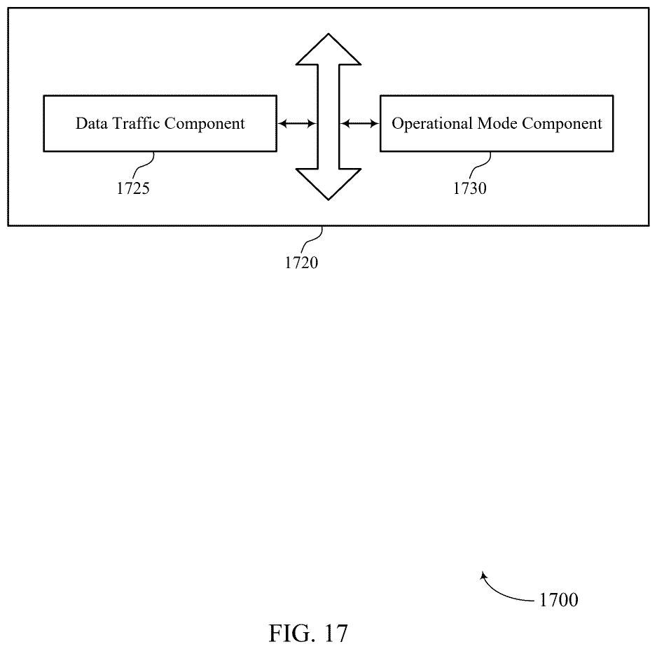

FIG. 17 shows a block diagram 1700 of a communications manager 1720 that supports techniques for RAN signaling for FEC awareness and PDU set information marking in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of techniques for RAN signaling for FEC awareness and PDU set information marking as described herein. For example, the communications manager 1720 may include a data traffic component 1725 an operational mode component 1730, or any combination thereof. Each of these components, or components or subcomponents thereof (e.g., one or more processors, one or more memories), may communicate, directly or indirectly, with one another (e.g., via one or more buses).

The communications manager 1720 may support wireless communications in accordance with examples as disclosed herein. The data traffic component 1725 is capable of, configured to, or operable to support a means for transmitting a request to receive a data traffic flow, where the data traffic flow includes one or more packet data unit (PDU) sets associated with a QoS flow. In some examples, the data traffic component 1725 is capable of, configured to, or operable to support a means for receiving at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

In some examples, a portion of PDUs of the one or more PDU sets is not received at the UE based on the at least one PDU satisfying the FEC content ratio for the PDU set of the one or more PDU sets.

In some examples, the operational mode component 1730 is capable of, configured to, or operable to support a means for transitioning into a sleep mode based on non-receipt of the portion of the one or more PDU sets.

Additionally, or alternatively, the communications manager 1720 may support wireless communications in accordance with examples as disclosed herein. In some examples, the data traffic component 1725 is capable of, configured to, or operable to support a means for transmitting a request to receive a data traffic flow, where the data traffic flow includes one or more packet data unit (PDU) sets associated with a QoS flow. In some examples, the data traffic component 1725 is capable of, configured to, or operable to support a means for receiving, via a radio access network (RAN) node and independent of whether a PDU set QoS configuration is associated with the QoS flow, at least one PDU set of the one or more PDU sets in accordance with a PDU set importance parameter included in PDU set information marking.

In some examples, a portion of PDU sets of the one or more PDU sets is not received at the UE based on the PDU set importance parameter.

In some examples, the PDU set information marking includes, for each PDU set, a PDU set sequence number, an indication of an end PDU, a PDU sequence number within a respective PDU set, a PDU set size, the PDU set importance parameter, or any combination thereof.

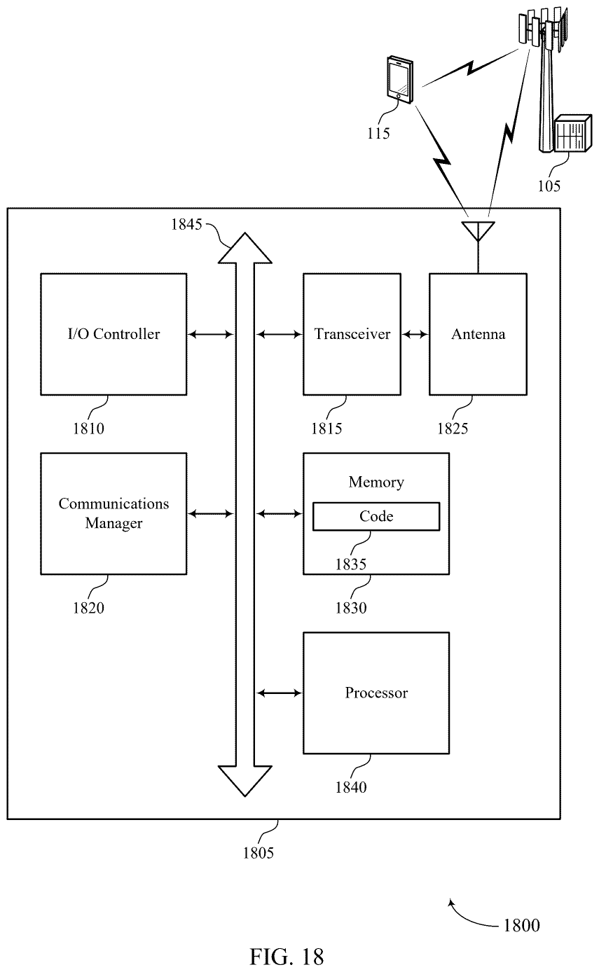

FIG. 18 shows a diagram of a system 1800 including a device 1805 that supports techniques for RAN signaling for FEC awareness and PDU set information marking in accordance with one or more aspects of the present disclosure. The device 1805 may be an example of or include components of a device 1505, a device 1605, or a UE 115 as described herein. The device 1805 may communicate (e.g., wirelessly) with one or more other devices (e.g., network entities 105, UEs 115, or a combination thereof). The device 1805 may include components for bi-directional voice and data communications including components for transmitting and receiving communications, such as a communications manager 1820, an input/output (I/O) controller, such as an I/O controller 1810, a transceiver 1815, one or more antennas 1825, at least one memory 1830, code 1835, and at least one processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of one or more processors, such as the at least one processor 1840. In some cases, a user may interact with the device 1805 via the I/O controller 1810 or via hardware components controlled by the I/O controller 1810.

In some cases, the device 1805 may include a single antenna. However, in some other cases, the device 1805 may have more than one antenna, which may be capable of concurrently transmitting or receiving multiple wireless transmissions. The transceiver 1815 may communicate bi-directionally via the one or more antennas 1825 using wired or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The at least one memory 1830 may include random access memory (RAM) and read-only memory (ROM). The at least one memory 1830 may store computer-readable, computer-executable, or processor-executable code, such as the code 1835. The code 1835 may include instructions that, when executed by the at least one processor 1840, cause the device 1805 to perform various functions described herein. The code 1835 may be stored in a non-transitory computer-readable medium such as system memory or another type of memory. In some cases, the code 1835 may not be directly executable by the at least one processor 1840 but may cause a computer (e.g., when compiled and executed) to perform functions described herein. In some cases, the at least one memory 1830 may include, among other things, a basic I/O system (BIOS) which may control basic hardware or software operation such as the interaction with peripheral components or devices.

The at least one processor 1840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1840 may be configured to operate a memory array using a memory controller. In some other cases, a memory controller may be integrated into the at least one processor 1840. The at least one processor 1840 may be configured to execute computer-readable instructions stored in a memory (e.g., the at least one memory 1830) to cause the device 1805 to perform various functions (e.g., functions or tasks supporting techniques for RAN signaling for FEC awareness and PDU set information marking). For example, the device 1805 or a component of the device 1805 may include at least one processor 1840 and at least one memory 1830 coupled with or to the at least one processor 1840, the at least one processor 1840 and the at least one memory 1830 configured to perform various functions described herein.

In some examples, the at least one processor 1840 may include multiple processors and the at least one memory 1830 may include multiple memories. One or more of the multiple processors may be coupled with one or more of the multiple memories, which may, individually or collectively, be configured to perform various functions described herein. In some examples, the at least one processor 1840 may be a component of a processing system, which may refer to a system (such as a series) of machines, circuitry (including, for example, one or both of processor circuitry (which may include the at least one processor 1840) and memory circuitry (which may include the at least one memory 1830)), or components, that receives or obtains inputs and processes the inputs to produce, generate, or obtain a set of outputs. The processing system may be configured to perform one or more of the functions described herein. For example, the at least one processor 1840 or a processing system including the at least one processor 1840 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code 1835 (e.g., processor-executable code) stored in the at least one memory 1830 or otherwise, to perform one or more of the functions described herein.

The communications manager 1820 may support wireless communications in accordance with examples as disclosed herein. For example, the communications manager 1820 is capable of, configured to, or operable to support a means for transmitting a request to receive a data traffic flow, where the data traffic flow includes one or more packet data unit (PDU) sets associated with a QoS flow. The communications manager 1820 is capable of, configured to, or operable to support a means for receiving at least one PDU of the one or more PDU sets, where the at least one PDU satisfies a forward error correction (FEC) content ratio for a PDU set of the one or more PDU sets, and where satisfaction of the FEC content ratio is determined on a per PDU set basis.

Additionally, or alternatively, the communications manager 1820 may support wireless communications in accordance with examples as disclosed herein. For example, the communications manager 1820 is capable of, configured to, or operable to support a means for transmitting a request to receive a data traffic flow, where the data traffic flow includes one or more packet data unit (PDU) sets associated with a QoS flow. The communications manager 1820 is capable of, configured to, or operable to support a means for receiving, via a radio access network (RAN) node and independent of whether a PDU set QoS configuration is associated with the QoS flow, at least one PDU set of the one or more PDU sets in accordance with a PDU set importance parameter included in PDU set information marking.

By including or configuring the communications manager 1820 in accordance with examples as described herein, the device 1805 may support techniques for improved communication reliability, reduced power consumption, more efficient utilization of communication resources, and longer battery life.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the at least one processor 1840, the at least one memory 1830, the code 1835, or any combination thereof. For example, the code 1835 may include instructions executable by the at least one processor 1840 to cause the device 1805 to perform various aspects of techniques for RAN signaling for FEC awareness and PDU set information marking as described herein, or the at least one processor 1840 and the at least one memory 1830 may be otherwise configured to, individually or collectively, perform or support such operations.

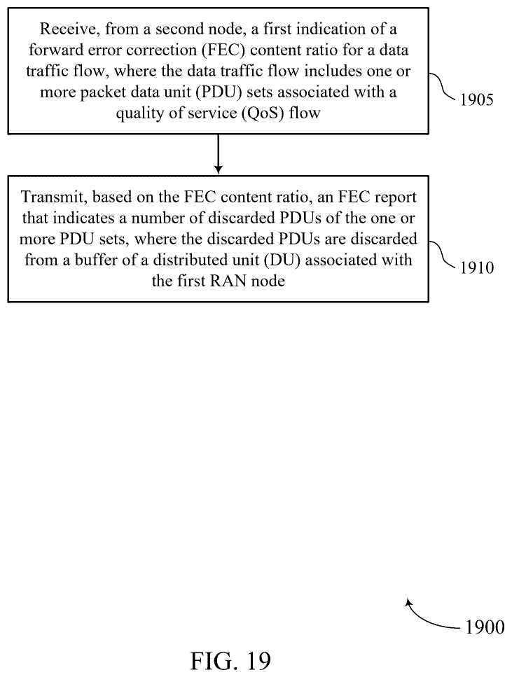

FIG. 19 shows a flowchart illustrating a method 1900 that supports techniques for RAN signaling for FEC awareness and PDU set information marking in accordance with one or more aspects of the present disclosure. The operations of the method 1900 may be implemented by a RAN node or its components as described herein. For example, the operations of the method 1900 may be performed by a RAN node as described with reference to FIGS. 1A through 14. In some examples, a RAN node may execute a set of instructions to control the functional elements of the RAN node to perform the described functions. Additionally, or alternatively, the RAN node may perform aspects of the described functions using special-purpose hardware.

At 1905, the method may include receiving, from a second node, a first indication of a forward error correction (FEC) content ratio for a data traffic flow, where the data traffic flow includes one or more packet data unit (PDU) sets associated with a QoS flow. The operations of 1905 may be performed in accordance with examples as disclosed herein. In some examples, aspects of the operations of 1905 may be performed by a FEC Content Ratio Component 1325 as described with reference to FIG. 13.

At 1910, the method may include transmitting, based on the FEC content ratio, an FEC report that indicates a number of discarded PDUs of the one or more PDU sets, where the discarded PDUs are discarded from a buffer of a DU associated with the first RAN node. The operations of 1910 may be performed in accordance with examples as disclosed herein. In some examples, aspects of the operations of 1910 may be performed by a FEC Measurement Report Component 1330 as described with reference to FIG. 13.

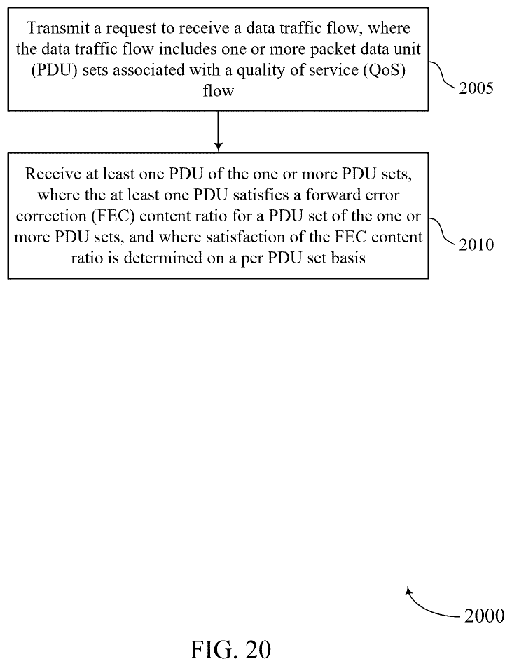

FIG. 20 shows a flowchart illustrating a method 2000 that supports techniques for RAN signaling for FEC awareness and PDU set information marking in accordance with one or more aspects of the present disclosure. The operations of the method 2000 may be implemented by a UE or its components as described herein. For example, the operations of the method 2000 may be performed by a UE 115 as described with reference to FIGS. 1A through 10 and 15 through 18. In some examples, a UE may execute a set of instructions to control the functional elements of the UE to perform the described functions. Additionally, or alternatively, the UE may perform aspects of the described functions using special-purpose hardware.

At 2005, the method may include transmitting a request to receive a data traffic flow, where the data traffic flow includes one or more packet data unit (PDU) sets associated with a QoS flow. The operations of 2005 may be performed in accordance with examples as disclosed herein. In some examples, aspects of the operations of 2005 may be performed by a data traffic component 1725 as described with reference to FIG. 17.

At 2010, the method may include receiving at least one PDU of the one or more PDU sets, where the at least one PDU satisfies a forward error correction (FEC) content ratio for a PDU set of the one or more PDU sets, and where satisfaction of the FEC content ratio is determined on a per PDU set basis. The operations of 2010 may be performed in accordance with examples as disclosed herein. In some examples, aspects of the operations of 2010 may be performed by a data traffic component 1725 as described with reference to FIG. 17.

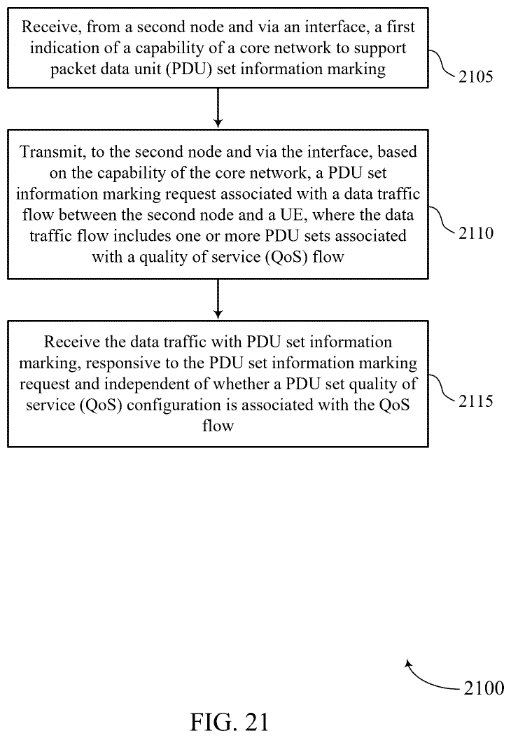

FIG. 21 shows a flowchart illustrating a method 2100 that supports techniques for RAN signaling for FEC awareness and PDU set information marking in accordance with one or more aspects of the present disclosure. The operations of the method 2100 may be implemented by a RAN node or its components as described herein. For example, the operations of the method 2100 may be performed by a RAN node as described with reference to FIGS. 1A through 14. In some examples, a RAN node may execute a set of instructions to control the functional elements of the RAN node to perform the described functions. Additionally, or alternatively, the RAN node may perform aspects of the described functions using special-purpose hardware.

At 2105, the method may include receiving, from a second node and via an interface, a first indication of a capability of a core network to support packet data unit (PDU) set information marking. The operations of 2105 may be performed in accordance with examples as disclosed herein. In some examples, aspects of the operations of 2105 may be performed by a PDU set information marking component 1335 as described with reference to FIG. 13.

At 2110, the method may include transmitting, to the second node and via the interface, based on the capability of the core network, a PDU set information marking request associated with a data traffic flow between the second node and a UE, where the data traffic flow includes one or more PDU sets associated with a QoS flow. The operations of 2110 may be performed in accordance with examples as disclosed herein. In some examples, aspects of the operations of 2110 may be performed by a PDU set information marking component 1335 as described with reference to FIG. 13.

At 2115, the method may include receiving the data traffic with PDU set information marking, responsive to the PDU set information marking request and independent of whether a PDU set QoS configuration is associated with the QoS flow. The operations of 2115 may be performed in accordance with examples as disclosed herein. In some examples, aspects of the operations of 2115 may be performed by a data traffic component 1340 as described with reference to FIG. 13.

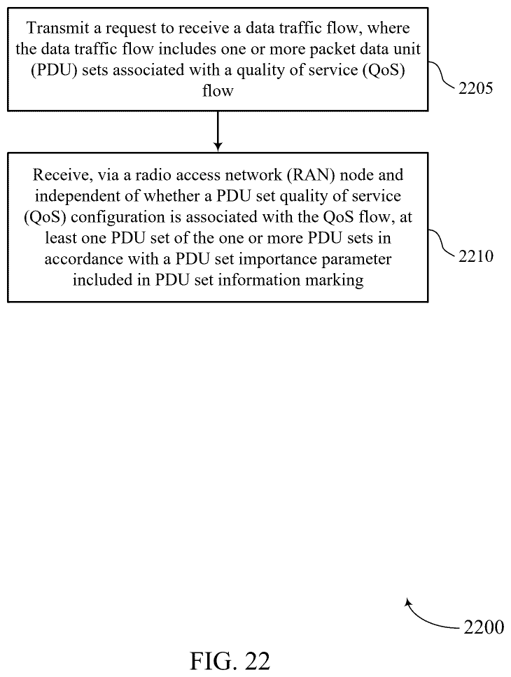

FIG. 22 shows a flowchart illustrating a method 2200 that supports techniques for RAN signaling for FEC awareness and PDU set information marking in accordance with one or more aspects of the present disclosure. The operations of the method 2200 may be implemented by a UE or its components as described herein. For example, the operations of the method 2200 may be performed by a UE 115 as described with reference to FIGS. 1A through 10 and 15 through 18. In some examples, a UE may execute a set of instructions to control the functional elements of the UE to perform the described functions. Additionally, or alternatively, the UE may perform aspects of the described functions using special-purpose hardware.

At 2205, the method may include transmitting a request to receive a data traffic flow, where the data traffic flow includes one or more packet data unit (PDU) sets associated with a QoS flow. The operations of 2205 may be performed in accordance with examples as disclosed herein. In some examples, aspects of the operations of 2205 may be performed by a data traffic component 1725 as described with reference to FIG. 17.

At 2210, the method may include receiving, via a radio access network (RAN) node and independent of whether a PDU set QoS configuration is associated with the QoS flow, at least one PDU set of the one or more PDU sets in accordance with a PDU set importance parameter included in PDU set information marking. The operations of 2210 may be performed in accordance with examples as disclosed herein. In some examples, aspects of the operations of 2210 may be performed by a data traffic component 1725 as described with reference to FIG. 17.

The following provides an overview of aspects of the present disclosure:
Aspect 1: A method for wireless communications by a first radio access network (RAN) node, comprising: receiving, from a second node, a first indication of a forward error correction (FEC) content ratio for a data traffic flow, wherein the data traffic flow includes one or more packet data unit (PDU) sets associated with a quality of service (QoS) flow; and transmitting, based at least in part on the FEC content ratio, an FEC report that indicates a number of discarded PDUs of the one or more PDU sets, wherein the discarded PDUs are discarded from a buffer of a distributed unit (DU) associated with the first RAN node.
Aspect 2: The method of aspect 1, wherein the first indication is included in an information element of a first message.
Aspect 3: The method of any of aspects 1 through 2, wherein the first indication is included in a first message at a QoS flow level.
Aspect 4: The method of any of aspects 1 through 3, wherein the first RAN node comprises a centralized unit-control plane (CU-CP), and the second node comprises a session management function (SMF) of a core network.
Aspect 5: The method of aspect 4, wherein the first indication is included in a PDU session resource setup request message or a PDU session resource modify request message.
Aspect 6: The method of any of aspects 4 through 5, further comprising: transmitting a second indication of the FEC content ratio to a centralized unit-user plane (CU-UP) associated with the first RAN node via an E1 interface, wherein the second indication is included in a bearer context setup request message or a bearer context modification request message.
Aspect 7: The method of any of aspects 4 through 6, further comprising: transmitting a second indication of the FEC content ratio to the DU via an F1 interface, wherein the second indication is included in a UE context setup request message or a UE context modification request message.
Aspect 8: The method of any of aspects 4 through 7, wherein the first RAN node is a source CU-CP, the method further comprising: transmitting a second indication of the FEC content ratio to a target CU-CP via an Xn interface, wherein the second indication is included in a handover request message or a retrieve UE context response message.
Aspect 9: The method of any of aspects 4 through 8, further comprising: receiving, from a centralized unit-user plane (CU-UP) associated with the first RAN node, a second indication of the discarded PDUs of the one or more PDU sets, wherein the second indication is per PDU set.
Aspect 10: The method of aspect 9, wherein the discarded PDUs comprise one or more of RLC PDUs discarded from an RLC transmission buffer of the DU, RLC PDUs discarded from an RLC retransmission buffer of the DU, segments of RLC PDUs discarded from the RLC retransmission buffer of the DU, medium access control (MAC) PDUs discarded from an HARQ retransmission buffer of the DU, or a combination thereof.
Aspect 11: The method of any of aspects 9 through 10, wherein the second indication comprises a PDU set sequence number associated with a PDU set of the one or more PDU sets, a number of discarded PDUs from the PDU set, a PDU sequence number associated with each of the discarded PDUs from the PDU set, or combinations thereof.
Aspect 12: The method of any of aspects 9 through 11, wherein the second indication is received over a New Radio (NR) interface via a downlink data delivery status message or a downlink data FEC status message.
Aspect 13: The method of any of aspects 9 through 12, further comprising: transmitting, to the DU, a third indication of activation of FEC reporting, wherein the second indication of the discarded PDUs is received based at least in part on the third indication.
Aspect 14: The method of aspect 13, wherein the third indication is transmitted to the DU via an F1 interface and is included in a UE context setup request message or a UE context modification request message.
Aspect 15: The method of any of aspects 4 through 14, further comprising: transmitting, to a centralized unit-user plane (CU-UP) associated with the first RAN node, a second indication of an FEC measurement and reporting configuration associated with a UE associated with the QoS flow.
Aspect 16: The method of aspect 15, wherein the second indication is transmitted via an F1 interface and is included in a bearer context setup request message or a bearer context modification request message.
Aspect 17: The method of any of aspects 15 through 16, further comprising: receiving, from the CU-UP, a third indication of a suggested FEC content ratio for inclusion in the FEC report.
Aspect 18: The method of any of aspects 15 through 17, further comprising: receiving, from the CU-UP, a third indication of an FEC measurement report in accordance with the FEC measurement and reporting configuration, wherein the FEC measurement report comprises one or more of a QoS flow identifier associated with the QoS flow, a total number of PDUs since a last FEC measurement report, a ratio of discarded PDUs to a total number of PDUs since a last FEC measurement report, a suggested FEC content ratio, or discarded PDU set information, and wherein the discarded PDU set information comprises, for each PDU set included in the discarded PDU set information, a PDU set sequence number associated with the PDU set and a ratio of discarded PDUs from the PDU set to a total number of PDUs in the PDU set, wherein the discarded PDU set information is based at least in part on discarded PDUs at the DU and on one or more PDUs remaining in a buffer of the CU-UP.
Aspect 19: The method of aspect 18, wherein the third indication is received via an E1 interface and is included in a downlink data notification message, a data usage report message or a UE measurement report message.
Aspect 20: The method of any of aspects 4 through 19, further comprising: receiving, from the SMF, a second indication of an FEC measurement and reporting configuration associated with a UE associated with the QoS flow.
Aspect 21: The method of aspect 20, wherein the second indication is received via an NG interface and is included in a measurement configuration request message, a PDU session resource setup request message, or a PDU session resource modify request message.
Aspect 22: The method of any of aspects 20 through 21, further comprising: determining, for each PDU set of the one or more PDU sets and based at least in part on discarded PDUs indicated in one or more FEC reports received from the DU or on one or more PDUs remaining in a buffer of the CU-CP, discarded PDU information.
Aspect 23: The method of aspect 22, wherein the FEC report is transmitted to the SMF and comprises one or more of a QoS flow identifier associated with the QoS flow, a total number of PDUs since a last FEC measurement report, a ratio of discarded PDUs to a total number of PDUs since a last FEC measurement report, a suggested FEC content ratio, or discarded PDU set information, and the discarded PDU set information comprises, for each PDU set included in the discarded PDU information, a PDU set sequence number associated with the PDU set and a ratio of discarded PDUs from the PDU set to a total number of PDUs in the PDU set.
Aspect 24: The method of aspect 23, wherein the FEC report is transmitted via an NG interface, and the FEC report is included in a measurement report message.
Aspect 25: The method of any of aspects 1 through 24, wherein the first RAN node comprises a centralized unit-user plane (CU-UP), the method further comprising: determining, for each PDU set of the one or more PDU sets and based at least in part on discarded PDUs indicated in one or more FEC reports received from the DU or on one or more PDUs remaining in a buffer of the CU-UP, discarded PDU information.
Aspect 26: The method of aspect 25, wherein the FEC report is transmitted to a user plane function (UPF) of a core network, based at least in part on the discarded PDU information, and via an uplink PDU session information frame of a PDU session user plane protocol, the FEC report comprises one or more of a total number of PDUs since a last FEC measurement report, a ratio of discarded PDUs to a total number of PDUs since a last FEC measurement report, a suggested FEC content ratio, and PDU set information, and the PDU set information comprises, for each PDU set included in the discarded PDU information, a PDU set sequence number associated with the PDU set and a ratio of discarded PDUs from the PDU set to a total number of PDUs in the PDU set.
Aspect 27: The method of any of aspects 1 through 26, further comprising: updating one or more QoS monitoring parameters to include information associated with the discarded PDUs.
Aspect 28: The method of aspect 27, further comprising: receiving, from an application function (AF) associated with a core network associated with the first RAN node, a request for measurements associated with at least one of the one or more QoS monitoring parameters.
Aspect 29: A method for wireless communications by a UE, comprising: transmitting a request to receive a data traffic flow, wherein the data traffic flow includes one or more packet data unit (PDU) sets associated with a quality of service (QoS) flow; and receiving at least one PDU of the one or more PDU sets, wherein the at least one PDU satisfies a forward error correction (FEC) content ratio for a PDU set of the one or more PDU sets, and wherein satisfaction of the FEC content ratio is determined on a per PDU set basis.
Aspect 30: The method of aspect 29, wherein a portion of PDUs of the one or more PDU sets is not received at the UE based at least in part on the at least one PDU satisfying the FEC content ratio for the PDU set of the one or more PDU sets.
Aspect 31: The method of aspect 30, further comprising: transitioning into a sleep mode based on non-receipt of the portion of the one or more PDU sets.
Aspect 32: A method for wireless communications by a first radio access network (RAN) node, comprising: receiving, from a second node and via an interface, a first indication of a capability of a core network to support packet data unit (PDU) set information marking; transmitting, to the second node and via the interface, based at least in part on the capability of the core network, a PDU set information marking request associated with a data traffic flow between the second node and a UE, wherein the data traffic flow includes one or more PDU sets associated with a quality of service (QoS) flow; and receiving the data traffic with PDU set information marking, responsive to the PDU set information marking request and independent of whether a PDU set quality of service (QoS) configuration is associated with the QoS flow.
Aspect 33: The method of aspect 32, wherein the PDU set information marking is used by the first RAN node in determination of whether the first RAN node is to forward individual ones of the one or more PDU sets to the UE.
Aspect 34: The method of any of aspects 32 through 33, wherein the PDU set information marking request comprises a PDU set information marking value that indicates activation or deactivation of PDU set information marking.
Aspect 35: The method of aspect 34, wherein the PDU set information marking value is included in a single bit information element of a second message.
Aspect 36: The method of any of aspects 32 through 35, wherein the interface is a next generation (NG) interface, and the second node is an access and mobility management function (AMF) of the core network.
Aspect 37: The method of aspect 36, wherein the first indication is included in a PDU session resource setup request message, a PDU session resource modify request message, or a path switch request acknowledge message, and the second indication is included in a PDU session resource setup response message, a PDU session resource modify response message, a PDU session resource modify indication message, a PDU session resource notify message, or a path switch request message.
Aspect 38: The method of any of aspects 36 through 37, wherein the first indication is included in a first message at a QoS flow level or at a PDU session level, and the PDU set information marking request is included in a second message at the QoS flow level or at the PDU session level.
Aspect 39: The method of any of aspects 32 through 38, wherein the interface comprises an E1 interface, and the first RAN node comprises a centralized unit-user plane (CU-UP) and the second node comprises a centralized unit-control plane (CU-CP) associated with the first RAN node.
Aspect 40: The method of aspect 39, wherein the first indication is included in a bearer context setup request message or a bearer context modification request message, and the second indication is included a bearer context setup response message, a bearer context modification response message, or a bearer context modification required message.
Aspect 41: The method of any of aspects 39 through 40, wherein the second indication is included in a CU-UP status indication message that includes one or more UE identifiers associated with the PDU set information marking request.
Aspect 42: The method of any of aspects 39 through 41, wherein the first indication is included in a first message at a QoS flow level, at a bearer level or at a PDU session level, and the PDU set information marking request is included in a second message at the QoS flow level, at the bearer level, or at the PDU session level.
Aspect 43: The method of any of aspects 32 through 42, wherein the interface comprises an F1 interface, and the first RAN node comprises a distributed unit (DU) and the second node comprises a centralized unit (CU) associated with the first RAN node.
Aspect 44: The method of aspect 43, wherein the first indication is included in a UE context setup request message or a UE context modification request message, and the second indication is included in a UE context setup response message, a UE context modification response message, a UE context modification required message, or a notify message.
Aspect 45: The method of any of aspects 43 through 44, wherein the first indication is included in a first message at a QoS flow level or at a data radio bearer (DRB) level, and the PDU set information marking request is included in a second message at the QoS flow level or at the DRB level.
Aspect 46: The method of any of aspects 43 through 45, wherein the second indication is included in a distributed unit (DU) status indication message that includes one or more UE identifiers associated with the PDU set information marking request.
Aspect 47: The method of any of aspects 32 through 46, wherein the interface comprises an Xn interface.
Aspect 48: The method of aspect 47, wherein the first RAN node is a target RAN node and the second node is a source RAN node, and the first indication is included in a handover request message.
Aspect 49: The method of any of aspects 47 through 48, wherein the second node is a future RAN node that is to replace the first RAN node in communication with the UE, and the first indication is included in a retrieve UE context response message.
Aspect 50: The method of any of aspects 47 through 49, wherein the first indication is included in a first message at a QoS flow level or at a PDU session level, and the PDU set information marking request is included in a second message at the QoS flow level or at the PDU session level.
Aspect 51: The method of any of aspects 47 through 50, wherein the first RAN node is a secondary RAN node and the second node is a master RAN node, the UE is in dual connectivity with the master RAN node and the secondary RAN node.
Aspect 52: The method of aspect 51, wherein the first indication is included in a secondary node (S-Node) addition request message or an S-Node modification request message, and the second indication is included in a S-Node addition request acknowledge message, an S-Node modification request acknowledge message, and S-Node modification required message, or an activity notification message.
Aspect 53: The method of any of aspects 51 through 52, wherein the first indication is included in a first message at a QoS flow level or at a data radio bearer (DRB) level, and the PDU set information marking request is included in a second message at the QoS flow level or at the DRB level.
Aspect 54: The method of any of aspects 51 through 53, wherein the first indication is included in a resource status request message, and the second indication is included in a resource status update message that includes one or more UE identifiers associated with the PDU set information marking request.
Aspect 55: The method of any of aspects 32 through 54, wherein the first RAN node comprises a distributed unit (DU) and the second node comprises a centralized unit user-plane (CU-UP) associated with the first RAN node, and the second indication is included in a user plane protocol assistance information data message.
Aspect 56: The method of any of aspects 32 through 55, wherein the first RAN node and the second node are in dual connectivity operation with the UE, and the second node hosts packet data convergence protocol (PDCP) during the dual connectivity operation, and the second indication is included in a user plane protocol assistance information data message.
Aspect 57: The method of any of aspects 32 through 56, wherein the first RAN node comprises a centralized unit-user plane (CU-UP) and the second node comprises a user plane function (UPF) of the core network, and the second indication is included in an uplink PDU session information message or downlink PDU set information marking request message.
Aspect 58: The method of aspect 57, wherein the downlink PDU set information marking request message comprises a marking request indicator and a marking request, the marking request indicator indicates whether the marking request is present.
Aspect 59: The method of any of aspects 32 through 58, wherein PDU set QoS parameters are not configured for the QoS flow.
Aspect 60: The method of any of aspects 32 through 59, further comprising: receiving, from the core network, a configuration of one or more PDU set QoS parameters, wherein the PDU set QoS parameters include a PDU set delay budget parameter, a PDU set error rate parameter, a PDU set integrated handling information indicator, or any combination thereof.
Aspect 61: The method of aspect 60, further comprising: transmitting a QoS report for the data traffic flow on a per PDU set basis, wherein the QoS report includes one or more of the PDU set QoS parameters.
Aspect 62: A method for wireless communications by a UE, comprising: transmitting a request to receive a data traffic flow, wherein the data traffic flow includes one or more packet data unit (PDU) sets associated with a quality of service (QoS) flow; and receiving, via a radio access network (RAN) node and independent of whether a PDU set quality of service (QoS) configuration is associated with the QoS flow, at least one PDU set of the one or more PDU sets in accordance with a PDU set importance parameter included in PDU set information marking.
Aspect 63: The method of aspect 62, wherein a portion of PDU sets of the one or more PDU sets is not received at the UE based at least in part on the PDU set importance parameter.
Aspect 64: The method of any of aspects 62 through 63, wherein the PDU set information marking includes, for each PDU set, a PDU set sequence number, an indication of an end PDU, a PDU sequence number within a respective PDU set, a PDU set size, the PDU set importance parameter, or any combination thereof.
Aspect 65: A first radio access network (RAN) node for wireless communications, comprising one or more memories storing processor-executable code, and one or more processors coupled with the one or more memories and individually or collectively operable to execute the code to cause the first radio access network (RAN) node to perform a method of any of aspects 1 through 28.
Aspect 66: A first radio access network (RAN) node for wireless communications, comprising at least one means for performing a method of any of aspects 1 through 28.
Aspect 67: A non-transitory computer-readable medium storing code for wireless communications, the code comprising instructions executable by one or more processors to perform a method of any of aspects 1 through 28.
Aspect 68: A UE for wireless communications, comprising one or more memories storing processor-executable code, and one or more processors coupled with the one or more memories and individually or collectively operable to execute the code to cause the UE to perform a method of any of aspects 29 through 31.
Aspect 69: A UE for wireless communications, comprising at least one means for performing a method of any of aspects 29 through 31.
Aspect 70: A non-transitory computer-readable medium storing code for wireless communications, the code comprising instructions executable by one or more processors to perform a method of any of aspects 29 through 31.
Aspect 71: A first radio access network (RAN) node for wireless communications, comprising one or more memories storing processor-executable code, and one or more processors coupled with the one or more memories and individually or collectively operable to execute the code to cause the first radio access network (RAN) node to perform a method of any of aspects 32 through 61.
Aspect 72: A first radio access network (RAN) node for wireless communications, comprising at least one means for performing a method of any of aspects 32 through 61.
Aspect 73: A non-transitory computer-readable medium storing code for wireless communications, the code comprising instructions executable by one or more processors to perform a method of any of aspects 32 through 61.
Aspect 74: A UE for wireless communications, comprising one or more memories storing processor-executable code, and one or more processors coupled with the one or more memories and individually or collectively operable to execute the code to cause the UE to perform a method of any of aspects 62 through 64.
Aspect 75: A UE for wireless communications, comprising at least one means for performing a method of any of aspects 62 through 64.
Aspect 76: A non-transitory computer-readable medium storing code for wireless communications, the code comprising instructions executable by one or more processors to perform a method of any of aspects 62 through 64.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first radio access network (RAN) node, comprising:
one or more memories storing processor-executable code; and
one or more processors coupled with the one or more memories and individually or collectively operable to execute the code to cause the first radio access network (RAN) node to:
receive, from a second node, a first indication of a forward error correction (FEC) content ratio for a data traffic flow, wherein the data traffic flow includes one or more packet data unit (PDU) sets associated with a quality of service (QoS) flow; and
transmit, based at least in part on the FEC content ratio, an FEC report that indicates a number of discarded PDUs of the one or more PDU sets, wherein the discarded PDUs are discarded from a buffer of a distributed unit (DU) associated with the first RAN node.

2. The first radio access network (RAN) node of claim 1, wherein:
the first RAN node comprises a centralized unit-control plane (CU-CP), and
the second node comprises a session management function (SMF) of a core network.

3. The first radio access network (RAN) node of claim 2, wherein the first indication is included in a PDU session resource setup request message or a PDU session resource modify request message.

4. The first radio access network (RAN) node of claim 2, wherein the one or more processors are individually or collectively further operable to execute the code to cause the first radio access network (RAN) node to:
transmit a second indication of the FEC content ratio to a centralized unit-user plane (CU-UP) associated with the first RAN node via an E1 interface, wherein the second indication is included in a bearer context setup request message or a bearer context modification request message.

5. The first radio access network (RAN) node of claim 2, wherein the one or more processors are individually or collectively further operable to execute the code to cause the first radio access network (RAN) node to:
transmit a second indication of the FEC content ratio to the DU via an F1 interface, wherein the second indication is included in a user equipment (UE) context setup request message or a UE context modification request message.

6. The first radio access network (RAN) node of claim 2, wherein the first RAN node is a source CU-CP, and the one or more processors are individually or collectively further operable to execute the code to cause the first radio access network (RAN) node to:
transmit a second indication of the FEC content ratio to a target CU-CP via an Xn interface, wherein the second indication is included in a handover request message or a retrieve user equipment (UE) context response message.

7. The first radio access network (RAN) node of claim 2, wherein the one or more processors are individually or collectively further operable to execute the code to cause the first radio access network (RAN) node to:
receive, from a centralized unit-user plane (CU-UP) associated with the first RAN node, a second indication of the discarded PDUs of the one or more PDU sets, wherein the second indication is per PDU set.

8. The first radio access network (RAN) node of claim 7, wherein the second indication is received over a New Radio (NR) interface via a downlink data delivery status message or a downlink data FEC status message.

9. The first radio access network (RAN) node of claim 7, wherein the one or more processors are individually or collectively further operable to execute the code to cause the first radio access network (RAN) node to:
transmit, to the DU, a third indication of activation of FEC reporting, wherein the second indication of the discarded PDUs is received based at least in part on the third indication.

10. The first radio access network (RAN) node of claim 9, wherein the third indication is transmitted to the DU via an F1 interface and is included in a user equipment (UE) context setup request message or a UE context modification request message.

11. The first radio access network (RAN) node of claim 2, wherein the one or more processors are individually or collectively further operable to execute the code to cause the first radio access network (RAN) node to:
transmit, to a centralized unit-user plane (CU-UP) associated with the first RAN node, a second indication of an FEC measurement and reporting configuration associated with a user equipment (UE) associated with the QoS flow.

12. The first radio access network (RAN) node of claim 11, wherein the second indication is transmitted via an F1 interface and is included in a bearer context setup request message or a bearer context modification request message.

13. The first radio access network (RAN) node of claim 11, wherein the one or more processors are individually or collectively further operable to execute the code to cause the first radio access network (RAN) node to:
receive, from the CU-UP, a third indication of a suggested FEC content ratio for inclusion in the FEC report.

14. The first radio access network (RAN) node of claim 11, wherein the one or more processors are individually or collectively further operable to execute the code to cause the first radio access network (RAN) node to:
receive, from the CU-UP, a third indication of an FEC measurement report in accordance with the FEC measurement and reporting configuration, wherein the FEC measurement report comprises one or more of a QoS flow identifier associated with the QoS flow, a total number of PDUs since a last FEC measurement report, a ratio of discarded PDUs to a total number of PDUs since a last FEC measurement report, a suggested FEC content ratio, or discarded PDU set information, and wherein the discarded PDU set information comprises, for each PDU set included in the discarded PDU set information, a PDU set sequence number associated with the PDU set and a ratio of discarded PDUs from the PDU set to a total number of PDUs in the PDU set, wherein the discarded PDU set information is based at least in part on discarded PDUs at the DU and on one or more PDUs remaining in a buffer of the CU-UP.

15. The first radio access network (RAN) node of claim 14, wherein the third indication is received via an E1 interface and is included in a downlink data notification message, a data usage report message or a user equipment (UE) measurement report message.

16. The first radio access network (RAN) node of claim 2, wherein the one or more processors are individually or collectively further operable to execute the code to cause the first radio access network (RAN) node to:
receive, from the SMF, a second indication of an FEC measurement and reporting configuration associated with a user equipment (UE) associated with the QoS flow.

17. The first radio access network (RAN) node of claim 16, wherein the second indication is received via an NG interface and is included in a measurement configuration request message, a PDU session resource setup request message, or a PDU session resource modify request message.

18. The first radio access network (RAN) node of claim 1, wherein the first RAN node comprises a centralized unit-user plane (CU-UP), and the one or more processors are individually or collectively further operable to execute the code to cause the first radio access network (RAN) node to:
determine, for each PDU set of the one or more PDU sets and based at least in part on discarded PDUs indicated in one or more FEC reports received from the DU or on one or more PDUs remaining in a buffer of the CU-UP, discarded PDU information.

19. A first user equipment (UE), comprising:
one or more memories storing processor-executable code; and
one or more processors coupled with the one or more memories and individually or collectively operable to execute the code to cause the first UE to:
transmit a request to receive a data traffic flow, wherein the data traffic flow includes one or more packet data unit (PDU) sets associated with a quality of service (QoS) flow; and
receive at least one PDU of the one or more PDU sets, wherein the at least one PDU satisfies a forward error correction (FEC) content ratio for a PDU set of the one or more PDU sets, and wherein satisfaction of the FEC content ratio is determined on a per PDU set basis.

20. A method for wireless communications by a first radio access network (RAN) node, comprising:
receiving, from a second node, a first indication of a forward error correction (FEC) content ratio for a data traffic flow, wherein the data traffic flow includes one or more packet data unit (PDU) sets associated with a quality of service (QoS) flow; and
transmitting, based at least in part on the FEC content ratio, an FEC report that indicates a number of discarded PDUs of the one or more PDU sets, wherein the discarded PDUs are discarded from a buffer of a distributed unit (DU) associated with the first RAN node.
